(19) United States
(12) Patent Application Publication
(10) Pub. No.: US 2018/0211447 A1
(43) Pub. Date: Jul. 26, 2018

(54) Methods and Systems for Using a Virtual or Augmented Reality Display to Perform Industrial Maintenance

(71) Applicant: Lonza Limited, Visp (CH)

(72) Inventor: Randall SPAYD, Rochester, NH (US)

(21) Appl. No.: 15/877,987

(22) Filed: Jan. 23, 2018

Related U.S. Application Data
(60) Provisional application No. 62/449,803, filed on Jan. 24, 2017.

(51) Int. Cl. G06T 19/00; G09B 19/00; G09B 25/02; G09B 5/06

(52) U.S. Cl. CPC G06T 19/006; G09B 5/065; G09B 25/02; G09B 19/003

(57) ABSTRACT

A method of providing a virtual reality or augmented reality display is provided. The method includes generating, with a camera of a device, first video content (e.g., a first video stream) that may include a depiction of a component of a facility for the processing of a pharmaceutical product, e.g., a biological product and detecting or selecting the component (e.g., a vessel, a pipe between a holding tank and a filter). The method also includes generating second video content that may include an indicator associated with the component (e.g., a vessel, pipe, holding tank, or filter), where the first video content and the second video content provides a virtual reality or augmented reality display.

### CROSS REFERENCE TO RELATED APPLICATIONS

This application claims priority to and the benefit of U.S. Provisional Application No. 62/449,803, filed Jan. 24, 2017, which is expressly incorporated herein by reference in its entirety.

### BACKGROUND ART

The application generally relates to visual display systems that depict one or more components of a facility (e.g., an industrial facility), such as virtual reality or augmented reality display systems, and more particularly, in one aspect, to systems and methods for providing such displays to be used in an industrial setting.

Industrial facilities, such as those engaged in manufacturing a drug or a biological product, may contain thousands of pieces of equipment, such as pipes, holding tanks, filters, valves, and so on. Many of those components may require inspection, monitoring, inventory analysis, maintenance, or replacement during their lifetime, and/or may fail or malfunction with little or no notice.

Maintenance of such systems introduces a number of issues. First, even locating a component at issue, and confirming that it is the correct component, may be difficult in facilities of sufficient size and/or complexity. Personnel may be provided with maps or instructions for locating the component, though interpreting such materials introduces the risk of human error. Further, the procedures to be performed may encompass or affect more than one component in more than one location, adding another layer of complexity. Second, the procedure itself may involve several steps that may be dictated by approved processes and governed by quality management standards, such as ISO 9001. Precision is important for reasons of compliance, efficiency, and safety. For that reason, specific, detailed instructions for carrying out the procedure may be provided to personnel in the form of a physical checklist. Yet such instructions may be unclear or non-intuitive and may be misinterpreted, leading to errors or safety concerns. In some instances, within the pharmaceutical and/or biotechnology industries, paper is not allowed in manufacturing space, which adds a challenge when providing technicians with meaningful and accurate instructions.

### SUMMARY OF THE INVENTION

The present disclosure relates to methods and systems for presenting a user with a visual display system that depicts one or more components of a facility (e.g., a production facility, such as an industrial facility), including an augmented reality or virtual reality display. The display may facilitate performing tasks (such as maintenance, diagnosis, or identification) in relation to components in the facility. The display may be part of a wearable device (e.g., a headset). A user wearing such a headset can be provided with information or tasks for one or more components in the field of vision of the user.

According to one aspect, a method of providing a virtual reality or augmented reality display is provided. The method includes acts generating, with a camera of a device, first video content (e.g., a first video stream) comprising a depiction of a component of a facility for the processing of a pharmaceutical product, e.g., a biological product; detecting or selecting the component (e.g., a vessel, a pipe between a holding tank and a filter); and generating second video content comprising an indicator associated with the component (e.g., a vessel, pipe, holding tank, or filter), the first video content and the second video content providing a virtual reality or augmented reality display.

According to one embodiment, the display is an augmented reality display. According to another embodiment, the display is provided by an augmented reality display system. According to still another embodiment, the display is a virtual reality display. According to yet another embodiment, the display is provided by a virtual reality display system. According to another embodiment, the indicator is selected from Table 1.

According to a further embodiment, the indicator is associated with the identity of the component, e.g., the type of component, e.g., a pump, serial number, part number or other identifier of the component. According to a still further embodiment, the method includes generating video content, e.g., the second video content, comprising a second indicator, e.g., an indicator form Table 1. According to a further embodiment, the method includes generating video content, e.g., the second video content, comprising a second, third, fourth, fifth, or subsequent indicator, e.g., an indicator from Table 1.

According to another embodiment, an indicator comprises a value for the function, condition, or status of the component or portion thereof. According to a further embodiment, the value comprises a current or real time value, a historical or past value, or a preselected value (e.g., the maximum or minimum value for the function, condition, or status (e.g., a preselected value occurring in a preselected time frame, such as since installation, in a specified time period, or since a predetermined event (e.g., last opening of a connected valve, last value of inspection)). According to another embodiment, a value for the indicator is compared with or presented with a reference value (e.g., the pressure is compared with or presented with a predetermined value for pressure (e.g., a predetermined allowable range for pressure)). According to another embodiment, the component is selected from Table 2.

According to one embodiment, the method further includes displaying, on a display device, a depiction of all or part of the component (e.g., all or part of the first video content) and the indicator (e.g., all or part of the second video content). According to another embodiment, the method further includes composing a display comprising a depiction of all or part of the component and the indicator. According to yet another embodiment, the method further includes composing a display comprising all or part of the first video content and all or part of the second video content. According to still another embodiment, the method further includes displaying, on a display device, all or part of the second video content, live or recorded, (e.g., the second video stream) and all or part of the first video content (e.g., first video stream), wherein all or part of the first video content is overlaid with all or part of the second video content, live or recorded.

According to one embodiment, the the first video content comprises a depiction of a plurality of components, further comprising receiving, at a display device, a selection (e.g., from an operator) of one of the plurality of components. According to another embodiment, the method further includes receiving location information from a location receiver (e.g., GPS), and identifying the component with reference to the location information. According to yet another embodiment, the method further includes receiving information about the component from a component identifier (e.g., RFID, barcode) on or sufficiently near the component to allow identification of the component.

According to one embodiment, the method further includes determining at least one action item (e.g., maintenance, repair, training, replacement, or adjustment of the component or a second component, a production task, e.g., adjustment of a process condition) to be performed with respect to the component. According to yet another embodiment, the method further includes determining that at least one action item is responsive to an indicator or value for an indicator (e.g., responsive to an indicator that the maximal hours or operation had been exceeded, determining that the component should be replaced, determining that a production process requires the action). According to a further embodiment, the method includes rechecking the component, e.g., repeating one or more steps of claim 1) after the at least one action item has been performed.

According to another embodiment, the method further includes entering into the system, information related to the component, e.g., action recommended or taken, such as inspection, repair, or replacement. According to a further embodiment, the information is recorded in a record, e.g., a database, or log.

According to another aspect, a display device is provided. The display device includes a camera configured to receive first video content (e.g., a first video stream) comprising a depiction of a component of an industrial facility for the processing of a drug or a biological product; a display screen configured to be positioned to be visible to a user of the display device; and a processor configured to generate first video content (e.g., a first video stream) comprising a depiction of a component of an industrial facility for the processing of a drug or a biological product, generate second video content comprising an indicator associated with the component (e.g., a pipe, holding tank, or filter), and display the first video content and the second video content as an augmented reality or virtual reality display.

According to one embodiment, the device includes a camera configured to capture the first video content. According to a further embodiment, the processor is configured to detect the component in the first video content.

According to one embodiment, the display device is a wearable device configured to be positioned in the field of vision of a wearer. According to a further embodiment, the processor is configured to display, on the display screen, a depiction of all or part of the component (e.g., all or part of the first video content) and the indicator (e.g., all or part of the second video content). According to a further embodiment, the processor is configured to compose a display comprising a depiction of all or part of the component and the indicator. According to a still further embodiment, the processor is configured to compose a display comprising all or part of the first video content and all or part of the second video content.

According to another embodiment, the processor is further configured display, on the display screen, all or part of the second video content (e.g., the second video stream) and all or part of the first video content (e.g., first video stream), wherein all or part of the first video content is overlaid with all or part of the second video content. According to one embodiment, the device includes a user interface configured to receive a user input. According to a further embodiment, the user input is a gesture of the user, the gesture being detected in the first video content. According to one embodiment, the first video content comprises a depiction of a plurality of components, and wherein the user interface is configured to receive a user selection of one of the plurality of components. According to a further embodiment, the first video content comprises a depiction of a plurality of components, and wherein the user interface is configured to receive a user selection of one of the plurality of components. According to another embodiment, the user interface is configured to receive a user interaction with the indicator, and wherein the processor is further configured to modify the indicator in response to the user interaction.

According to another embodiment, the device includes a location receiver (e.g., GPS) configured to obtain location information, wherein the processor is further configured to identify the component with reference to the location information. According to one embodiment, the device includes a radio receiver (e.g., RFID) configured to receive a proximity signal from a signaling device on or near the component, wherein the processor is further configured to identify the component with reference to the proximity signal. According to another embodiment, the device includes a network interface configured to communicate with at least one computer via a network. According to yet another embodiment, the device includes a memory configured to store at least one of a portion of the first video content and the indicator.

According to one embodiment, the device further includes at least one of a gyroscope, an accelerometer, and a compass. According to another embodiment, the device includes protective components for the eyes, face, or head of the user. According to yet another embodiment, the device is configured to fit the user while the user is wearing protective gear for the eyes, face, or head of the user. According to another embodiment, the device is configured to fit the user while the user is wearing a contained breathing system.

According to another aspect, a method of displaying visual content is provided. The method includes acts of displaying, to a user of a display device, a display composed of first video content (e.g., a first video stream) comprising a depiction of a component of an industrial facility for the processing of a drug or a biological product, and second video content comprising an indicator associated with the component (e.g., a vessel, a pipe, holding tank, or filter), the first video content and the second video content providing an augmented reality display; and receiving user input via a user interface of the display device.

According to one embodiment, the display is an augmented reality display. According to another embodiment, the display is a virtual reality display. According to yet another embodiment, receiving the user input comprises detecting a gesture of the user in the first video content. According to one embodiment, the method further includes, responsive to a value for the indicator (e.g., value indicating that the component has reached x hours of operation), creating a further indicator for the component or a second component. According to another embodiment, the method further includes receiving input associating the further indicator with a different user.

According to one embodiment, the method further includes, responsive to the indicator or a value for the indicator, sending a signal to an entity (e.g., a system operator, or maintenance engineer, or facility manager). According to another embodiment, the method further includes capturing some or all of the first video content and/or the second video content to be stored in a memory.

According to one embodiment, the method further includes detecting, in the first video content, an event (escape of fluid or gas, presence of alarm), and creating a further indicator relating to the event. According to a further embodiment, the method includes transmitting a signal about the event to an entity (e.g., a system operator, or maintenance engineer, or facility manager). According to one embodiment, the method further includes receiving, via a network interface of the device, information about the component.

According to another embodiment, the indicator comprises information about an action item to be performed relative to the component. According to a further embodiment, the action item is presented as part of a task list in the second video content. According to another embodiment, the action item relates to at least one of a maintenance task or an industrial process involving the component. According to yet another embodiment, the task list includes an action item relating to the component and an action item relating to another component. According to another embodiment, the user input indicates an action taken with respect to the action item.

According to yet another embodiment, the second video content includes a further indicator providing a direction to a location of a component. According to a still further embodiment, some or all of the second video content is displayed in a color corresponding to a characteristic of the component, the indicator, or a value of the indicator. According to another embodiment, the characteristic is a type of the component, an identifier of the component, an identifier of a material stored or transmitted by the component, or a temperature of the material stored or transmitted by the component.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of a display device for providing a visual display, such as a virtual reality or augmented reality display according to one or more embodiments;

FIG. 2 is a representation of a user interface of a display device according to one or more embodiments;

FIG. 3 is a representation of a user interface of a display device according to one or more embodiments;

FIG. 4 is a representation of a user interface of a display device according to one or more embodiments;

FIG. 5 is a representation of a user interface of a display device according to one or more embodiments;

FIG. 6 is a representation of a user interface of a display device according to one or more embodiments;

FIG. 7 is a representation of a user interface of a display device according to one or more embodiments;

FIG. 8 is a representation of a user interface of a display device according to one or more embodiments; and

FIG. 9 is a block diagram of one example of a computer system on which aspects and embodiments of the present invention may be implemented.

### DETAILED DESCRIPTION OF EMBODIMENTS OF THE INVENTION

Aspects of the present disclosure relate to methods and systems for presenting a user with a visual display system that depicts one or more components of a facility (e.g., an augmented reality or virtual reality display) to assist a user in performing tasks such as inspection, monitoring, inventory analysis, maintenance, diagnosis, or identification in relation to components in a facility. In one embodiment, the facility is a production facility, such as an industrial facility. The display may be part of a wearable device (e.g., a headset). A user wearing such a headset can look around the industrial facility and be provided with information or tasks for one or more components in the field of vision of the user, the field which may be variable.

In one aspect or operating mode, the display may be a virtual reality display in which three-dimensional visual content is generated and displayed to the user, with the view of the content changing according to a position of the device. In another aspect or operating mode, the display may be an augmented reality display in which video content captured by the device is displayed and overlaid with context-specific generated visual content. Systems and methods for creating such augmented or virtual reality displays are discussed in U.S. Pat. No. 6,040,841, titled “METHOD AND SYSTEM FOR VIRTUAL CINEMATOGRAPHY,” issued Mar. 21, 2000, and in U.S. Pat. No. 9,285,592, titled “WEARABLE DEVICE WITH INPUT AND OUTPUT STRUCTURES,” issued Mar. 15, 2016, the contents of each of which are hereby incorporated in their entirety for all purposes.

In one example, maintenance personnel wearing the device may be presented with a visual representation of the component, documents detailing component history, and/or a visual list of tasks for completing a maintenance procedure on the component. As the user completes a task on the list, the list may be updated (either automatically or by an interaction from the user, such as a gesture) to remove the completed task.

In another example, personnel looking at one or more components in the industrial facility may be presented with information about the component, including identity information or information associated with age, date installed, manufacturer, availability of replacement units, expected life cycle, function, condition, or status of the component. Such information may include a temperature of a material in the component, a flow rate through the component, or a pressure in the component. Other information may be provided, such as recent issues or events involving the component or inspection results. Such information may be presented textually, such as by overlaying a textual value (e.g., temperature) over the component in the display, by visual representation of a file/document that can be opened and displayed on the overlay, or may be presented graphically, such as by shading the component in a color according to a value (e.g., displaying the component in a shade of red according to the temperature of the material inside it).

In yet another example, personnel looking at one or more components currently experiencing a malfunction or other issue may be presented with information about the malfunction, and may further be presented with an interface for creating an alert condition, notifying others, or otherwise addressing the malfunction.

In any of these examples, the user may be presented with the opportunity to document a procedure, condition, malfunction, or other aspect of an interaction with the component. For example, the user may be provided the opportunity to record video and/or capture photographs while viewing the component. This content may be used to document the completion of a procedure, or may be stored or provided to others for purposes of documenting or diagnosing one or more issues with the component.

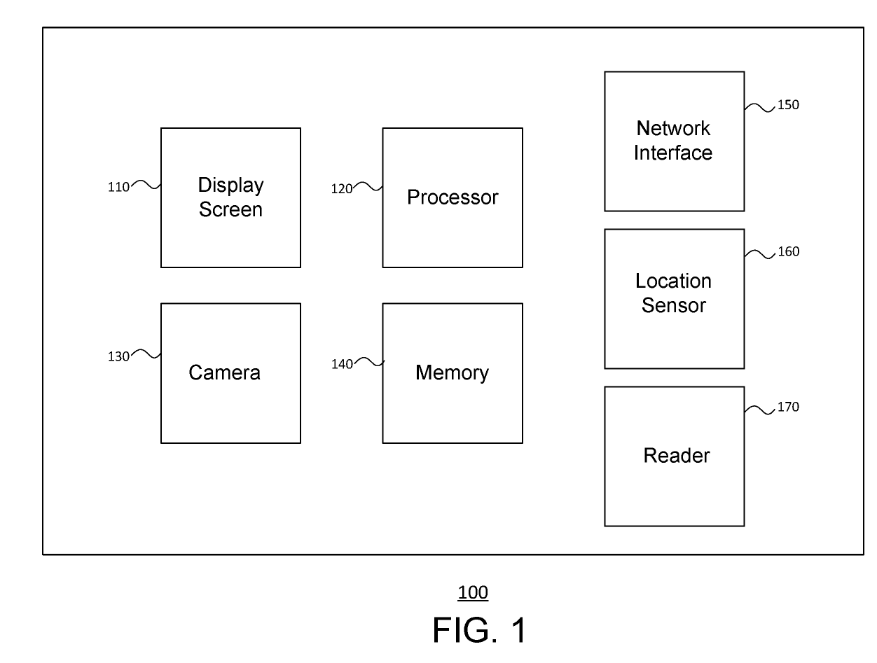

A block diagram of a display device 100 for presenting augmented reality or virtual reality display information to a user in an industrial facility according to some embodiments is shown in FIG. 1. The display device includes at least one display screen 110 configured to provide a virtual reality or augmented reality display to a user of the display device 100. The display may include video or photographs of one or more components in the industrial facility, or may include a computer graphic (e.g., a three-dimensional representation) of the one or more components.

At least one camera 130 may be provided to capture video streams or photographs for use in generating the virtual reality or augmented reality display. For example, video of the industrial facility, including of one or more components, may be captured to be displayed as part of an augmented reality display. In some embodiments, two display screens 110 and two cameras 130 may be provided. Each display screen 110 may be disposed over each eye of the user. Each camera 130 may capture a video stream or photographic content from the relative point of view of each eye of the user, and the content may be displayed on the respective display screens 110 to approximate a three-dimensional display. The at least one camera 130 may be configured to capture images at various resolutions or at different frame rates. Many video cameras with a small form-factor, such as those used in cell phones or webcams, for example, may be incorporated into embodiments of the device 100.

A processor 120 is provided for capturing the video stream or photographs from the at least one camera 130 and causing the at least one display screen 110 to display video content to the user. The processor 120 contains an arithmetic logic unit (ALU) (not shown) configured to perform computations, a number of registers (not shown) for temporary storage of data and instructions, and a control unit (not shown) for controlling operation of the device 100. Any of a variety of processors, including those from Digital Equipment, MIPS, IBM, Motorola, NEC, Intel, Cyrix, AMD, Nexgen and others may be used. Although shown with one processor 120 for ease of illustration, device 100 may alternatively include multiple processing units.

The processor 120 may be configured to detect one or more components in the images of the video stream using computer vision, deep learning, or other techniques. The processor 120 may make reference to GPS data, RFID data, or other data to identify components in proximity of the device 100 and/or in the field of vision of the at least one camera 130. In some embodiments, the processor 120 may also identify one or more barcodes and/or QR code in the video stream, and use the identifier encoded in the barcodes to identify associated components.

A memory 140 is provided to store some or all of the captured content from the at least one camera 130, as well as to store information about the industrial facility or one or more components therein. The memory 140 may include both main memory and secondary storage. The main memory may include high-speed random access memory (RAM) and read-only memory (ROM). The main memory can also include any additional or alternative high speed memory device or memory circuitry. The secondary storage is suited for long-term storage, such as ROM, optical or magnetic disks, organic memory or any other volatile or non-volatile mass storage system.

Video streams captured from at least one camera 130 may be stored in the memory, in whole or in part. For example, the user may store portions of video streams of interest (or expected interest) by selectively recording to the memory 140 (such as by use of a start/stop recording button). In other embodiments, a recent portion of the video stream (e.g., the last 10 seconds, 30 second, 60 seconds, etc.) may be stored in the memory 140 on a rolling basis, such as with a circular buffer.

A network interface 150 is provided to allow communication between the device 100 and other systems, including a server, other devices, or the like. In some embodiments, the network interface 150 may allow the processor 120 to communicate with a control system of the industrial facility. The processor 120 may have certain rights to interact with the control system, such as by causing the control system to enable, disable, or otherwise modify the function of components of the control system.

The network interface 150 may be configured to create a wireless communication, using one or more protocols such as Bluetooth® radio technology (including Bluetooth Low Energy), communication protocols described in IEEE 802.11 (including any IEEE 802.11 revisions), Cellular technology (such as GSM, CDMA, UMTS, EVDO, WiMAX, or LTE), or Zigbee® technology, among other possibilities. In other embodiments, a wired connection may be provided.

In some embodiments, the video stream may be transmitted continuously (e.g., in real time, or near-real time) to a server or other system via the network interface 150, allowing others to see what the user is seeing or doing, either in real time or later. Transmitting the video stream to a storage system may allow it to be reviewed, annotated, and otherwise preserved as a record for later use, such as during an audit or as part of a compliance or maintenance record.

A location sensor 160 (e.g., a GPS receiver) may be provided to allow the processor 120 to determine the current location of the display device 100. Coordinates of locations and/or components within the industrial facility may be known; the use of the GPS receiver to determine a current location of the device 100 may therefore allow for identification of components in proximity of the device 100. A reader 170 (e.g., RFID reader) may also be provided to allow the processor 120 to detect a current location from one or more signals. In some embodiments, individual components may be provided with transmitters (e.g., RFID chips) configured to provide information about the components when in the proximity of device 100. Other sensors (not shown) may be provided, including at least one accelerometer, at least one gyroscope, and a compass, the individual or combined output of which can be used to determine an orientation, movement, and/or location of the device 100.

In some embodiments, the processor 120 is configured to detect gestures made by the user and captured in the video stream. For example, the processor 120 may detect that one or more of the user's arms and/or hands has moved in any number of predefined or user-defined gestures, including but not limited to swipes, taps, drags, twists, pushes, pulls, zoom-ins (e.g., by spreading the fingers out), zoom-outs (by pulling the fingers in), or the like. Gestures may be detected when they are performed in a gesture region of a display or display content, which will be further described below; the gesture region may be a subregion of the display or display content, or may cover substantially all of the display or display content.

In response to such gestures, the device 100 may take a corresponding action relative to one or more elements on the display screen 110. In other embodiments, the user may interact with the device 100 by clicking physical or virtual buttons on the device 100.

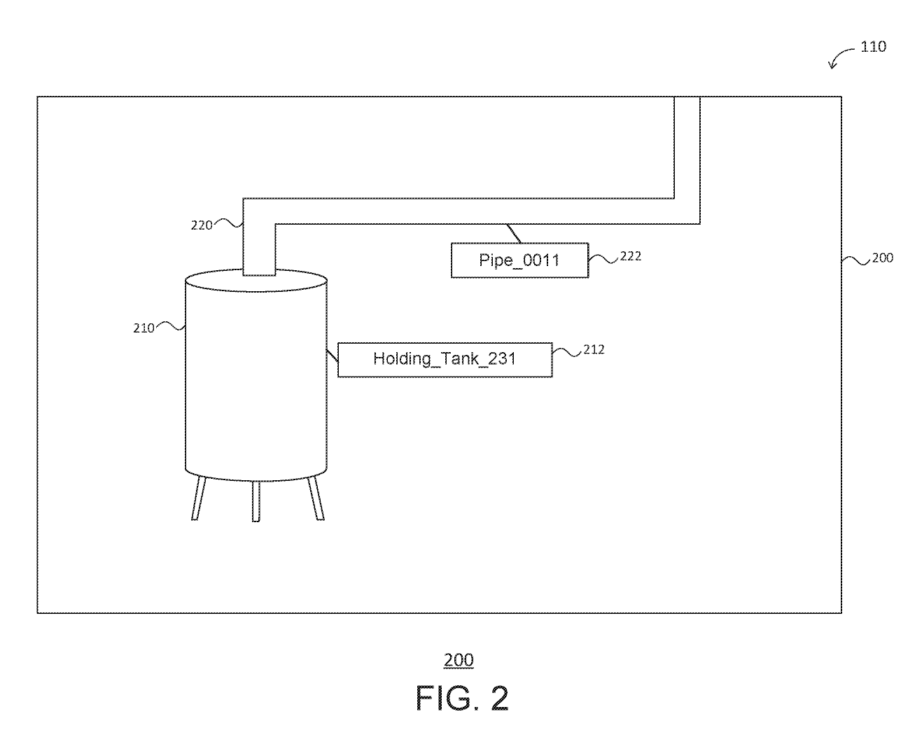

When the device 100 is used in an industrial facility, the display screen may show representations of components in the vicinity of the device 100, along with overlaid information about those components, including age, date installed, manufacturer, availability of replacement units, expected life cycle, function, condition, or status of the component. An illustration of exemplary display content 200 displayed on a display screen 110 of a device 100 is shown in FIG. 2. The display content 200 includes representations of components 210 and 220, a holding tank and a pipe, respectively. The components 210, 220 may be displayed in a first video content region and may appear as video or photographic images (in the case of an augmented reality display) or as three-dimensional representations of components 210, 220 in a current region of the industrial facility.

Indicators 212, 222 corresponding to components 210, 220 respectively are overlaid to provide information about each component 210, 220. The indicators 212, 222 may be displayed as a second video content region that overlays the first video content region. The second video content region may be partially transparent so that the first video content region is visible except where visual display elements are disposed on the second video content region, in which case those visual display elements may obscure the underlying portion of the first video content region. The second video content region and/or the visual display elements thereon may also be partially transparent, allowing the first video content region to be seen to some degree behind the second video content region.

The indicators 212, 222 include information about the components 212, 222, including identifying information, such as a name, number, serial number, or other designation for each component. In some embodiments, the indicators 212, 222 may indicate the part number or type of component (e.g., a pump), or the lot number of the component.

Indicators 212, 222 may be displayed for most or all components. For example, when a user of the device 100 walks through the industrial facility and looks around, each component visible in the display may have an associated indicator. These components may be arranged in layers so that, in some cases, they can be turned on and off via a visible layer definition overlay similar to 212 or 222. In other embodiments, only certain component may have an indicator. Criteria may be defined for which components should be displayed with indicators, and may be predefined or set by the user prior to or during use of the device 100. For example, indicators may be displayed only for certain types of components (e.g., pipes), only for components involved in a particular industrial process, or only for components on which maintenance is currently being performed.

In some embodiments, the user may be provided the opportunity to interact with the indicators 212, 222 in order to change the indicators 212, 222, or to obtain different or additional information about the corresponding components 210, 220. The interaction may take place via a gesture by the user. For example, an additional display space (such as an expanded view of the indicator 212, 222) may display current or historical information about the component 210 or a material within it, such as a value, condition, or status of the component or a portion thereof. The value may include a minimum and/or maximum of a range of acceptable values for the component. For example, the information displayed may include minimum and maximum temperature or pressure values that act as a normal operating range; when values outside the range are experienced, alarms may issue or other actions may be taken.

Installation, operation, and maintenance information may also be displayed, such as the date of installation, financial asset number, the date the component was last inspected or maintained, the date the component is next due to be inspected or maintained, or the number of hours the component has been operated, either in its lifetime or since an event, such as the most recent maintenance event. Information about historical maintenance or problems/issues may also be displayed. For example, the user may be provided the opportunity to view maintenance records for the component.

Information may also be obtained from third-party sources. For example, the availability of replacement parts for the component (or replacement components themselves) may be obtained from third-parties, such as vendors, and displayed. The user may be informed, for example, as to when a replacement part is expected to be in stock, or the number of replacement parts currently in stock at a vendor.

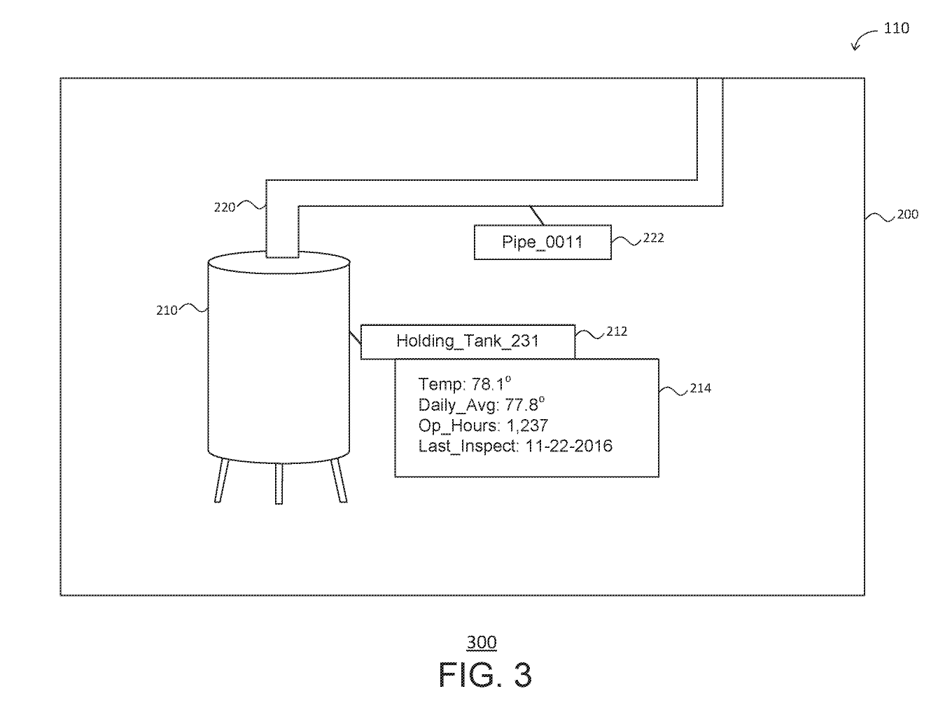

Another view 300 of the display content 200 is shown in FIG. 3. In this view, the user has interacted with the indicator 212, such as by performing a “click” gesture. In response, the indicator 212 has been expanded to provide additional information about the component 210 as part of an expanded indicator 214. The expanded indicator 214 shows values for the current temperature of the material inside the component 210, a daily average of the temperature of the material inside the component 210, the number of hours the component 210 has been in operation since installation, and the date on which the component 210 was last inspected.

The indicator 212 and/or the expanded indicator 214 may be displayed in a position relative to the displayed location of the component 210 that is determined according to ergonomics, visibility, and other factors. For example, the indicator 212 and/or the expanded indicator 214 may be displayed to one side of, or above or below, the component 210, to allow both of the component 210 and the indicator 212 and/or the expanded indicator 214 to be viewed simultaneously. In another example, the indicator 212 and/or the expanded indicator 214 may be displayed as an opaque or semi-transparent overlay over the component 210. In another example, the indicator 212 may be displayed as an overlay over the component 210, but upon interaction by the user, the expanded indicator 214 may be displayed to one side of, or above or below, the component 210. This approach allows the indicator 212 to be closely visually associated with the component 210 as a user moves among possibly many components. Transitioning to the expanded indicator 214 indicates that the component 210 is of interest, however, meaning that the user may wish to view component 210 and the expanded indicator 214 simultaneously.

The user may be permitted to move the indicators 212, 222 and/or expanded indicator 214 through the use of gestures or otherwise in order to customize the appearance of the display content 200. For example, the user may perform a “drag” gesture on expanded indicator 214 and move expanded indicator 214 up, down, left, or right. Because the display content 200 is three-dimensional, the user may drag the expanded indicator 214 to appear closer by “pulling” it toward to user, or may “push” the expanded indicator 214 away so that it appears further away relative to the component 210. The indicator 212 and/or the expanded indicator 214 may be graphically connected to the component 210 by a connector or other visual association cue. As the indicators 212, 222 and/or the expanded indicator 214 are moved relative to the component 210, the connector is resized and reoriented to continuously maintain the visual connection. In a situation where the indicators 212, 222 and/or the expanded indicator 214 are required to display more information than will fit in them visually, the indicators 212, 222 and/or the expanded indicator 214 may have scrolling functionality.

The indicators 212, 222 and/or the expanded indicator 214 may include current and/or historical information about the component or its performance, the material in the component, and processes performed by or on the component. Exemplary indicators are provided in Table 1:

TABLE 1
Indicators
Exemplary indicators include indicators associated with:

the identity of the component, e.g., the type of component, e.g., a pump, serial number, part
number or other identifier of the component;
information relevant to maintenance or replacement of the component (e.g., an indicator that
component maintenance is required, an indicator associated with the date a component was
installed, a scheduled replacement date or event; the availability of replacement components
(e.g., available from a source such as a vendor or a supply depot)
information related to a second component to which the component is functionally linked,
e.g., a second component in fluid connection with the component;
information associated with a function, condition, or status of the component (e.g.,
temperature, flow rate through the device, pressure in the device; recent issues or events
involving the component, inspection results, current production lot number in production
equipment/component);
information associated with the service life of the component (e.g., time in use, date of next
service)
Information associated with the age of the component.
Information associated with the date the component was installed.
Information associated with the manufacturer of the component.
Information associated with the availability of a replacement for the component.
Information associated with the location of a replacement for the component.
Information associated with the expected life cycle of the component.
Information associated with the function of the component.
Information associated with the condition of the component.
Information associated with the status of the component.
Information associated with the temperature of the component or of a material in the
component.
Information associated with the flow rate through the component.
Information associated with a flow rate through the component.
Information associated with a pressure in the component.
Information associated with an event or an inspection of the component.

Components may include, but are not limited to, the following listed in Table 2:

TABLE 2
Components
Exemplary components include:

| | |
|---|---|
| tank | evaporator |
| pipe | centrifuge |
| filter | press |
| mixer | conveyor |
| reactor | boiler |
| fermentor | pump |
| condenser | scrubber |
| valve | separator |
| gauge | dryer |
| heat exchanger | cooker |
| regulator | decanter |
| column | freezer |

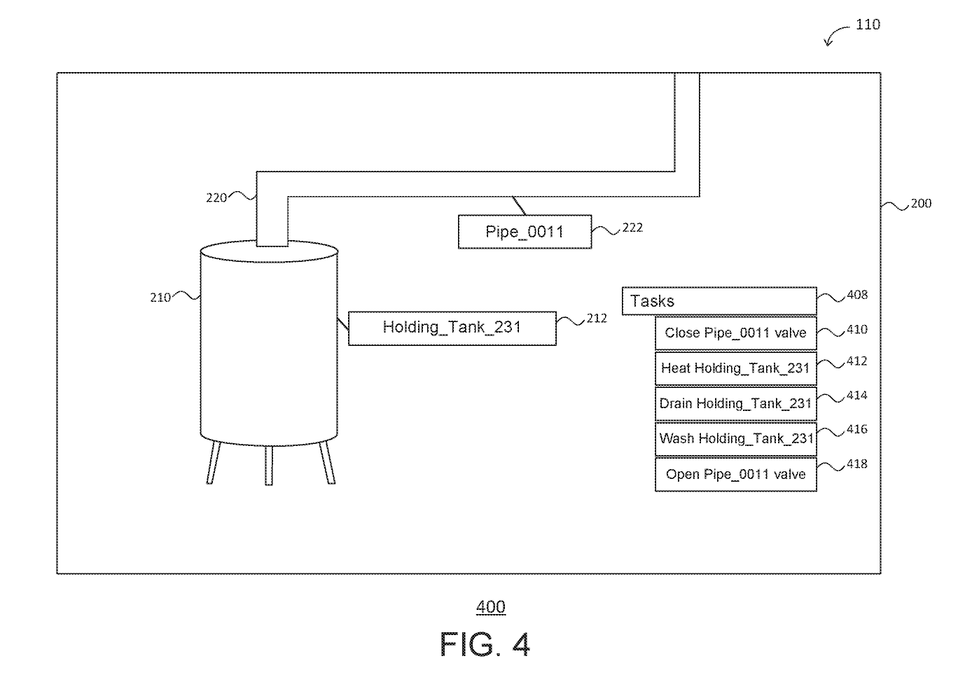

Yet another view 400 of the display content 200 is shown in FIG. 4. In this view, the user is presented the display content 200 with a task list 408. The task list 408 contains one or more tasks, such as tasks 410 to 418, that the user may wish to complete. The tasks may be related to one or more of production tasks, maintenance tasks, inspection/audit tasks, inventory tasks, or the like. When a task list 408 is displayed, indicators 212, 222 and/or expanded indicator 214 may be displayed only for those components relevant to the task list 408. In some embodiments, the user may select the task list 408 and/or the tasks 410 to 418, causing only the indicators 212, 222 and/or the expanded indicator 214 relevant to the task list 408 and/or the selected task 410 to 418, respectively, to be displayed.

As one or more tasks 410 to 418 are completed by the user, the user may update a status of the task, such as by marking it complete. For example, the user may perform a “swipe” gesture on task 410, causing it to disappear or otherwise be removed from the list. The remaining tasks 412 to 418 in the task list 408 may move upward. In another example, the user may perform a “click” gesture on task 410, causing it to be marked complete, which may be represented visually by a check mark next to the task 410, a graying out or other visual de-emphasis of the task 410, or otherwise. A notification that one or more tasks have been completed may be transmitted via network interface 150 to a computerized maintenance management system or other business software system for tracking.

The task list 408 may be expandable, in that a user performing a gesture on a particular task creates an expanded view with additional information about the task. Such additional information may include more detailed instructions for the task (including any pre-steps, sub-steps, or post-steps necessary for the task), safety information, historical information relating to when the task was last performed on the related component, or the like.

The task list 408 and/or the individual tasks 410 to 418 may be preloaded onto the device 100, either by the user or other personnel, or automatically according to scheduled maintenance or observed issues or conditions that need to be addressed. The task list 408 and/or the tasks 410 to 418 may also be uploaded to the device 100 via the network interface 150.

In other embodiments, the task list 408 and/or the individual tasks 410 to 418 may be created and/or modified in real-time by the user during use. In some embodiments, verbal commands may be received and processed by the device 100, allowing the user to dynamically create, modify, or mark as complete tasks on the task list 408.

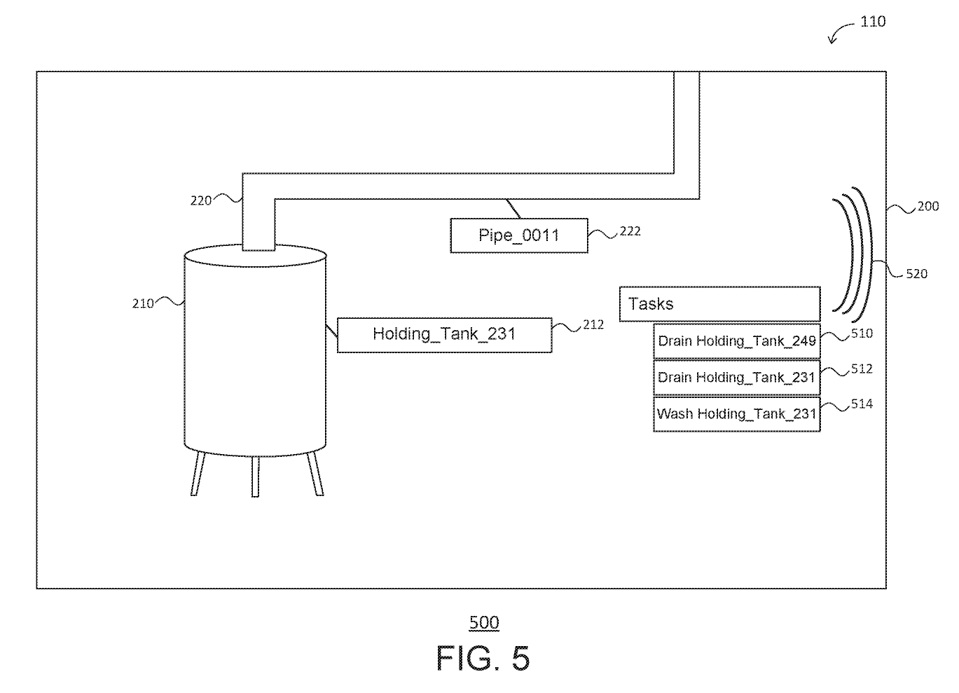

Yet another view 500 of the display content 200 is shown in FIG. 5. In this view, the user is again presented the display content 200 with a task list. In this example, however, the first task on the list, task 510, relates to a component (not shown) called “holding tank 249” that is not currently visible in the display content 200. For example, the component may be off the edge of the display, or may be in a completely different part of the facility. A direction indicator 520 is therefore used to guide the user in the direction of the component, the location of which may be stored in in the device 100 or determined by the location sensor 160 and/or the reader 170. In some examples, the direction indicator 520 may be a series of lines or arrows, as seen in FIG. 5. In other examples, a region of the display indicative of the direction of the component may glow, pulse, or otherwise change appearance. In still other examples, audio indications or other commands (such as spoken directions) may be given through an earpiece or otherwise.

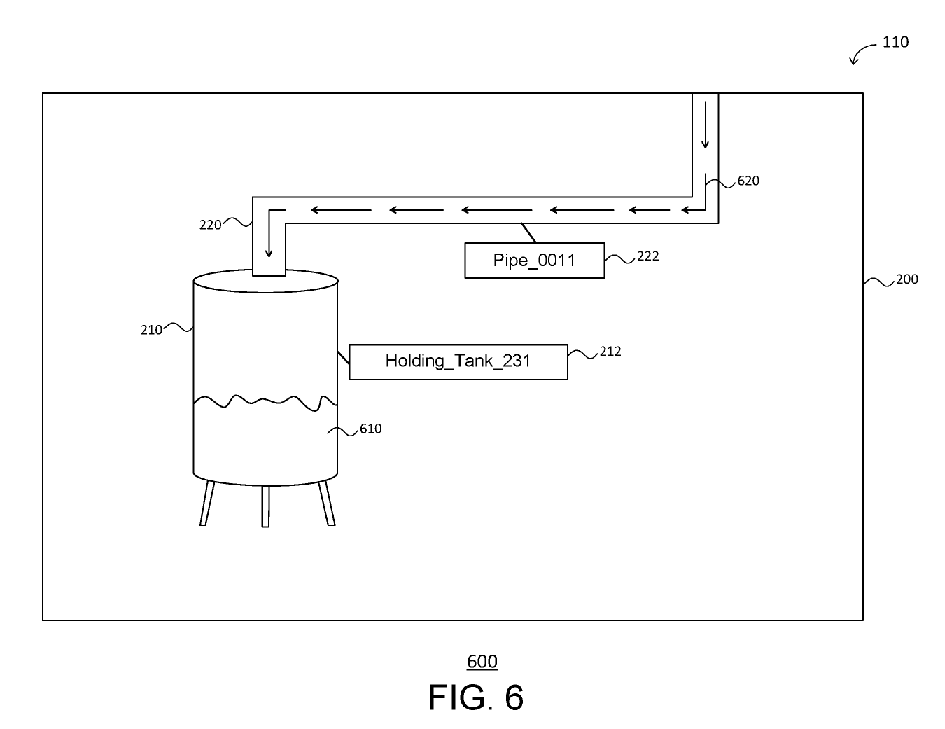

In some embodiments, overlays or other graphical features may be shown in relation to the components in order to convey additional information about the component or a material inside. Another view 600 of the display content 200 is shown in FIG. 6. In this view, the display content shows a number of graphical data features 610, 620 that provide additional or enhanced information about the components 210, 220. The graphical data features 610, 620 may be displayed as overlays in an augmented reality display, or as additional graphics in a virtual reality display.

The graphical data feature 610 provides one or more pieces of information about the material stored in the holding tank that is component 210. For example, the dimensions of the graphical data feature 610 may indicate a volume of fluid in the holding tank. In other words, one or more dimensions (e.g., the height) of graphical data feature 610 may correspond to a level of fluid in the tank, with the top of the graphical data feature 610 displayed at a position approximating the surface of the fluid in the component 210. In this manner, the user can intuitively and quickly “see” how much fluid remains in the component 210.

Other aspects of the graphical data feature 610 may indicate additional information. For example, the graphical data feature 610 may glow, flash, pulse, or otherwise change appearance to indicate that the component 210 (or the material inside) requires attention or maintenance. As another example, the graphical data feature 610 may indicate, by its color or otherwise, information about the nature of the material inside. For example, if the component 210 holds water, the graphical data feature 610 may appear blue. Other color associations may be used, such as a yellow indicating gas, green indicating oxygen, and the like. As another example, handling or safety characteristics may be indicated by the color of the graphical data feature 610. For example, a material that is a health hazard may be indicated by a graphical data feature 610 that is blue; a flammable material may be indicated by a red graphical data feature 610; a reactive material may be indicated by a yellow graphical data feature 610; a corrosive material may be indicated by a white graphical data feature 610; and so on. Other common or custom color schemes may be predefined and/or customized by the user.

In other embodiments, a graphical data feature may not be sized or shaped differently than the corresponding component. For example, the entire component may be overlaid or colored to provide information about the component.

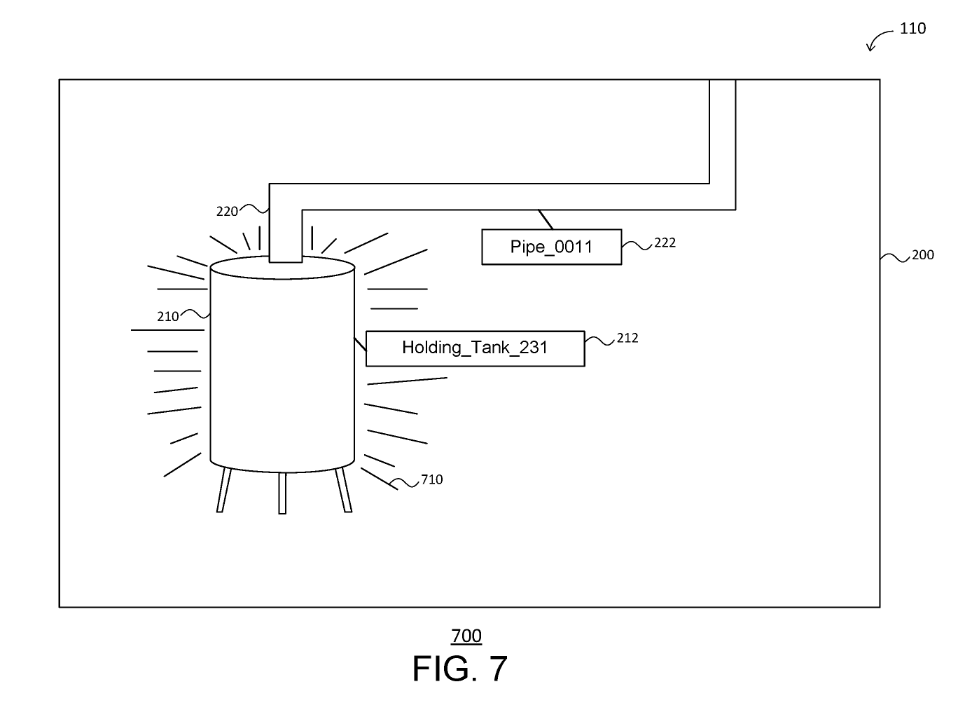

Another view 700 of the display content 200 is shown in FIG. 7. In this example, the graphic data feature 710 is coextensive with the area of the component 210 in the display content 200. The entire component 210 may be visually emphasized by the graphic data feature 710 to draw attention to the component 710 for the purpose of identification, expressing safety concerns, performing tasks, etc. For example, the graphic data feature 710 may cause the entire component 210 to appear to glow, flash, pulse, or otherwise change appearance.

Graphic data features (e.g., graphic data features 610, 710) may change appearance to indicate that the associated component is in a non-functional or malfunctioning state, needs service, is operating outside of a defined range (e.g., temperature), etc.

Returning to FIG. 6, graphical data features may also provide information about a current function of the component. For example, component 220 (a pipe) is overlaid with graphic data feature 620, which may be a series of arrows, lines, or the like that are animated to indicate a flow through the component 220. The graphical data feature 620 may visually indicate such information as the direction, flow rate, and amount of turbulence in the flow. For example, the size of the arrows/lines, or the speed or intensity of the animation, may indicate the magnitude of the flow. As another example, a graphical data feature may visually indicate that a motor or fan inside a component is working.

The display content 200 may also include one or more interactive elements for causing certain functions to be performed.

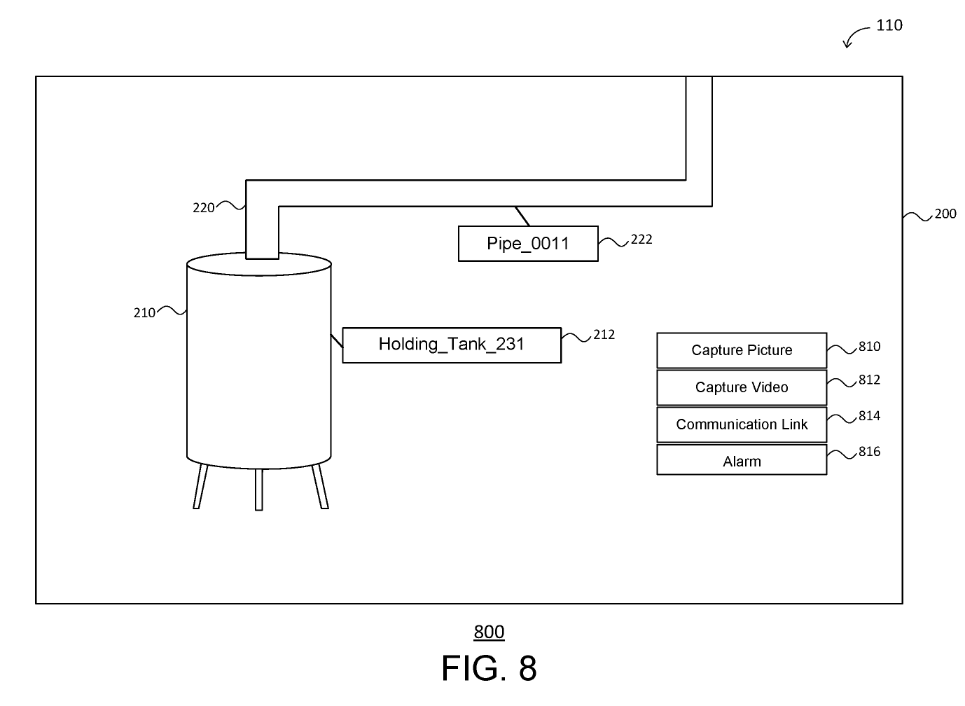

Another view 800 of the display content 200 is shown in FIG. 8. In this view, a number of user interface buttons 810 to 816 are provided to allow a user to capture a picture (e.g., of what is seen in the display content 200), capture a video, communicate with another person or system (such as a control room), or trigger an alarm, respectively. The buttons 810 to 816 may be activated by the user performing a gesture in the display content 200, such as using a finger to “click” them. The buttons 810 to 816 may be context-specific, so that moving around the industrial facility and/or interacting with different components causes buttons associated with different functionalities to appear. In other embodiments, such tasks may be performed by the user performing a gesture.

Referring again to FIG. 1, the processor 120 may be configured to detect one or more events captured in video streams and/or photographs, or otherwise detected from sensors of the device 100. For example, the processor 120 may detect an explosion or other event, such as a burst of steam or a rapid discharge of fluid, in a video stream captured by the camera 130. As another example, the processor 120 may determine, from the output of a gyroscope and/or accelerometer, that the user's balance or movements are irregular, or even that the employee has fallen and/or lost consciousness. As another example, the processor 120 may determine, from one or more audio sensors (e.g., microphones), that an alarm is sounding, or that the user or others are yelling or otherwise indicating, through tone, inflection, volume, or language, that an emergency may be occurring. Upon making such a determination, the processor 120 may cause an alarm to sound, may contact supervisory or management staff, emergency personnel, or others (e.g., via network interface 150), may begin recording the video stream or otherwise documenting current events, or may automatically take action with respect to one or more components, or prompt the user to do so.

Consider a scenario in which a valve of a pipe component has burst, causing extremely hot steam to emit from the pipe at a high rate, endangering personnel. The processor 120 may detect the event in the video stream and/or audio stream, for example, by comparing the video stream to known visual characteristics of a steam leak, and/or comparing audio input from one or more microphones to known audio characteristics of a steam leak. In response, the processor 120 may cause an alarm in the industrial facility to sound, may begin recording video and/or audio of the event for documentation and later analysis, and may cause a control system of the industrial facility to address the event, for example, by closing off an upstream valve on the pipe, thereby stopping the leak until a repair can be made.

The device 100 may be provided in one or more commercial embodiments. For example, the components and functionality described herein may be performed, in whole or in part, by virtual or augmented reality glasses (e.g., the Microsoft Hololens offered by the Microsoft Corporation, Redmond, Wash., or Google Glass offered by Google of Mountain View, Calif.), a headset, or a helmet.

The device 100 may be incorporated into, or designed to be compatible with, protective equipment of the type worn in industrial facilities. For example, the device 100 may be designed to be removably attached to a respirator, so that both the respirator and the device 100 can be safely and comfortably worn. In another example, the device 100 may be designed to fit the user comfortably and securely without preventing the user from wearing a hardhat or other headgear.

In other embodiments, the device 100 may be provided as hardware and/or software on a mobile phone or tablet device. For example, a user may hold the device 100 up to one or more components such that a camera of the device 100 (e.g., a tablet device) is oriented toward the component. The photographs and/or video captured by the camera may be used to form the displays described herein.

Example Computer System

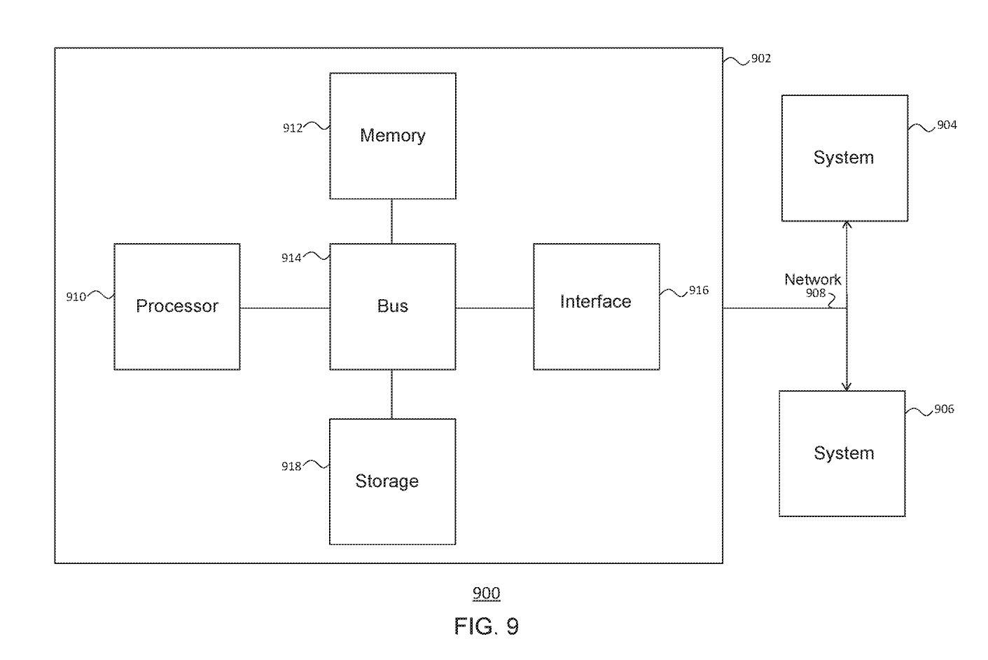

FIG. 9 is a block diagram of a distributed computer system 900, in which various aspects and functions discussed above may be practiced. The distributed computer system 900 may include one or more computer systems, including the device 100. For example, as illustrated, the distributed computer system 800 includes three computer systems 902, 904, and 906. As shown, the computer systems 902, 904 and 906 are interconnected by, and may exchange data through, a communication network 908. The network 908 may include any communication network through which computer systems may exchange data. To exchange data via the network 908, the computer systems 902, 904, and 906 and the network 908 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA HOP, RMI, DCOM and Web Services.

According to some embodiments, the functions and operations discussed for producing a three-dimensional synthetic viewpoint can be executed on computer systems 902, 904 and 906 individually and/or in combination. For example, the computer systems 902, 904, and 906 support, for example, participation in a collaborative network. In one alternative, a single computer system (e.g., 902) can generate the three-dimensional synthetic viewpoint. The computer systems 902, 904 and 906 may include personal computing devices such as cellular telephones, smart phones, tablets, “fablets,” etc., and may also include desktop computers, laptop computers, etc.

Various aspects and functions in accord with embodiments discussed herein may be implemented as specialized hardware or software executing in one or more computer systems including the computer system 902 shown in FIG. 9. In one embodiment, computer system 902 is a personal computing device specially configured to execute the processes and/or operations discussed above. As depicted, the computer system 902 includes at least one processor 910 (e.g., a single core or a multi-core processor), a memory 912, a bus 914, input/output interfaces (e.g., 916) and storage 918. The processor 910, which may include one or more microprocessors or other types of controllers, can perform a series of instructions that manipulate data. As shown, the processor 910 is connected to other system components, including a memory 912, by an interconnection element (e.g., the bus 914).

The memory 912 and/or storage 918 may be used for storing programs and data during operation of the computer system 902. For example, the memory 912 may be a relatively high performance, volatile, random access memory such as a dynamic random access memory (DRAM) or static memory (SRAM). In addition, the memory 912 may include any device for storing data, such as a disk drive or other non-volatile storage device, such as flash memory, solid state, or phase-change memory (PCM). In further embodiments, the functions and operations discussed with respect to generating and/or rendering synthetic three-dimensional views can be embodied in an application that is executed on the computer system 902 from the memory 912 and/or the storage 918. For example, the application can be made available through an “app store” for download and/or purchase. Once installed or made available for execution, computer system 902 can be specially configured to execute the functions associated with producing synthetic three-dimensional views.

Computer system 902 also includes one or more interfaces 916 such as input devices (e.g., camera for capturing images), output devices and combination input/output devices. The interfaces 916 may receive input, provide output, or both. The storage 918 may include a computer-readable and computer-writeable nonvolatile storage medium in which instructions are stored that define a program to be executed by the processor. The storage system 918 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 902 may include an operating system that manages at least a portion of the hardware components (e.g., input/output devices, touch screens, cameras, etc.) included in computer system 902. One or more processors or controllers, such as processor 910, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 902 is shown by way of example as one type of computer system upon which various functions for producing three-dimensional synthetic views may be practiced, aspects and embodiments are not limited to being implemented on the computer system, shown in FIG. 9. Various aspects and functions may be practiced on one or more computers or similar devices having different architectures or components than that shown in FIG. 9.

### INDUSTRIAL APPLICATIONS

Devices, systems, and methods of using such devices and systems, e.g., a visual display system, e.g., a visual display system that depicts one or more components of a facility, e.g., an augmented reality or virtual reality display, can be used in a number of industrial settings, e.g., in industrial installations which produce a pharmaceutical product. The facility can be a production facility or an industrial facility. The facility, e.g., industrial facility or installation, can be a production facility, e.g., for pilot, scaled-up, or commercial production. Such facilities include industrial facilities that include components that are suitable for culturing any desired cell line including prokaryotic and/or eukaryotic cell lines. Also included are industrial facilities that include components that are suitable for culturing suspension cells or anchorage-dependent (adherent) cells and are suitable for production operations configured for production of pharmaceutical and biopharmaceutical products—such as polypeptide products, nucleic acid products (for example DNA or RNA), or cells and/or viruses such as those used in cellular and/or viral therapies.

In embodiments, the cells express or produce a product, such as a recombinant therapeutic or diagnostic product. As described in more detail below, examples of products produced by cells include, but are not limited to, antibody molecules (e.g., monoclonal antibodies, bispecific antibodies), antibody mimetics (polypeptide molecules that bind specifically to antigens but that are not structurally related to antibodies such as e.g. DARPins, affibodies, adnectins, or IgNARs), fusion proteins (e.g., Fc fusion proteins, chimeric cytokines), other recombinant proteins (e.g., glycosylated proteins, enzymes, hormones), viral therapeutics (e.g., anti-cancer oncolytic viruses, viral vectors for gene therapy and viral immunotherapy), cell therapeutics (e.g., pluripotent stem cells, mesenchymal stem cells and adult stem cells), vaccines or lipid-encapsulated particles (e.g., exosomes, virus-like particles), RNA (such as e.g. siRNA) or DNA (such as e.g. plasmid DNA), antibiotics or amino acids. In embodiments, the devices, facilities and methods can be used for producing biosimilars.

Also included are industrial facilities that include components that allow for the production of eukaryotic cells, e.g., mammalian cells or lower eukaryotic cells such as for example yeast cells or filamentous fungi cells, or prokaryotic cells such as Gram-positive or Gram-negative cells and/or products of the eukaryotic or prokaryotic cells, e.g., proteins, peptides, antibiotics, amino acids, nucleic acids (such as DNA or RNA), synthesised by the eukaryotic cells in a large-scale manner. Unless stated otherwise herein, the devices, facilities, and methods can include any desired volume or production capacity including but not limited to bench-scale, pilot-scale, and full production scale capacities.

Moreover and unless stated otherwise herein, the facility can include any suitable reactor(s) including but not limited to stirred tank, airlift, fiber, microfiber, hollow fiber, ceramic matrix, fluidized bed, fixed bed, and/or spouted bed bioreactors. As used herein, “reactor” can include a fermentor or fermentation unit, or any other reaction vessel and the term “reactor” is used interchangeably with “fermentor.” For example, in some aspects, an example bioreactor unit can perform one or more, or all, of the following: feeding of nutrients and/or carbon sources, injection of suitable gas (e.g., oxygen), inlet and outlet flow of fermentation or cell culture medium, separation of gas and liquid phases, maintenance of temperature, maintenance of oxygen and CO2 levels, maintenance of pH level, agitation (e.g., stirring), and/or cleaning/sterilizing. Example reactor units, such as a fermentation unit, may contain multiple reactors within the unit, for example the unit can have 1, 2, 3, 4, 5, 10, 15, 20, 25, 30, 35, 40, 45, 50, 60, 70, 80, 90, or 100, or more bioreactors in each unit and/or a facility may contain multiple units having a single or multiple reactors within the facility. In various embodiments, the bioreactor can be suitable for batch, semi fed-batch, fed-batch, perfusion, and/or a continuous fermentation processes. Any suitable reactor diameter can be used. In embodiments, the bioreactor can have a volume between about 100 mL and about 50,000 L. Non-limiting examples include a volume of 100 mL, 250 mL, 500 mL, 750 mL, 1 liter, 2 liters, 3 liters, 4 liters, 5 liters, 6 liters, 7 liters, 8 liters, 9 liters, 10 liters, 15 liters, 20 liters, 25 liters, 30 liters, 40 liters, 50 liters, 60 liters, 70 liters, 80 liters, 90 liters, 100 liters, 150 liters, 200 liters, 250 liters, 300 liters, 350 liters, 400 liters, 450 liters, 500 liters, 550 liters, 600 liters, 650 liters, 700 liters, 750 liters, 800 liters, 850 liters, 900 liters, 950 liters, 1000 liters, 1500 liters, 2000 liters, 2500 liters, 3000 liters, 3500 liters, 4000 liters, 4500 liters, 5000 liters, 6000 liters, 7000 liters, 8000 liters, 9000 liters, 10,000 liters, 15,000 liters, 20,000 liters, and/or 50,000 liters. Additionally, suitable reactors can be multi-use, single-use, disposable, or non-disposable and can be formed of any suitable material including metal alloys such as stainless steel (e.g., 316L or any other suitable stainless steel) and Inconel, plastics, and/or glass.

In embodiments and unless stated otherwise herein, the facility can also include any suitable unit operation and/or equipment not otherwise mentioned, such as operations and/or equipment for separation, purification, and isolation of such products. Any suitable facility and environment can be used, such as traditional stick-built facilities, modular, mobile and temporary facilities, or any other suitable construction, facility, and/or layout. For example, in some embodiments modular clean-rooms can be used. Additionally and unless otherwise stated, the devices, systems, and methods described herein can be housed and/or performed in a single location or facility or alternatively be housed and/or performed at separate or multiple locations and/or facilities.

By way of non-limiting examples and without limitation, U.S. Publication Nos. 2013/0280797; 2012/0077429; 2011/0280797; 2009/0305626; and U.S. Pat. Nos. 8,298,054; 7,629,167; and 5,656,491, which are hereby incorporated by reference in their entirety, describe example facilities, equipment, and/or systems that may be suitable.

In embodiments, the facility can include the use of cells are eukaryotic cells, e.g., mammalian cells. The mammalian cells can be for example human or rodent or bovine cell lines or cell strains. Examples of such cells, cell lines or cell strains are e.g. mouse myeloma (NSO)-cell lines, Chinese hamster ovary (CHO)-cell lines, HT1080, H9, HepG2, MCF7, MDBK Jurkat, NIH3T3, PC12, BHK (baby hamster kidney cell), VERO, SP2/0, YB2/0, YO, C127, L cell, COS, e.g., COS1 and COS7, QC1-3, HEK-293, VERO, PER.C6, HeLA, EB1, EB2, EB3, oncolytic or hybridoma-cell lines. Preferably the mammalian cells are CHO-cell lines. In one embodiment, the cell is a CHO cell. In one embodiment, the cell is a CHO-K1 cell, a CHO-K1 SV cell, a DG44 CHO cell, a DUXB11 CHO cell, a CHOS, a CHO GS knock-out cell, a CHO FUT8 GS knock-out cell, a CHOZN, or a CHO-derived cell. The CHO GS knock-out cell (e.g., GSKO cell) is, for example, a CHO-K1 SV GS knockout cell. The CHO FUT8 knockout cell is, for example, the Potelligent® CHOK1 SV (Lonza Biologics, Inc.). Eukaryotic cells can also be avian cells, cell lines or cell strains, such as for example, EBx® cells, EB14, EB24, EB26, EB66, or EBv13.

In one embodiment, the eukaryotic cells are stem cells. The stem cells can be, for example, pluripotent stem cells, including embryonic stem cells (ESCs), adult stem cells, induced pluripotent stem cells (iPSCs), tissue specific stem cells (e.g., hematopoietic stem cells) and mesenchymal stem cells (MSCs).

In one embodiment, the cell is a differentiated form of any of the cells described herein. In one embodiment, the cell is a cell derived from any primary cell in culture.

In embodiments, the cell is a hepatocyte such as a human hepatocyte, animal hepatocyte, or a non-parenchymal cell. For example, the cell can be a plateable metabolism qualified human hepatocyte, a plateable induction qualified human hepatocyte, plateable Qualyst Transporter Certified™ human hepatocyte, suspension qualified human hepatocyte (including 10-donor and 20-donor pooled hepatocytes), human hepatic kupffer cells, human hepatic stellate cells, dog hepatocytes (including single and pooled Beagle hepatocytes), mouse hepatocytes (including CD-1 and C57BI/6 hepatocytes), rat hepatocytes (including Sprague-Dawley, Wistar Han, and Wistar hepatocytes), monkey hepatocytes (including Cynomolgus or Rhesus monkey hepatocytes), cat hepatocytes (including Domestic Shorthair hepatocytes), and rabbit hepatocytes (including New Zealand White hepatocytes). Example hepatocytes are commercially available from Triangle Research Labs, LLC, 6 Davis Drive Research Triangle Park, N.C., USA 27709.

In one embodiment, the eukaryotic cell is a lower eukaryotic cell such as e.g. a yeast cell (e.g., Pichia genus (e.g. Pichia pastoris, Pichia methanolica, Pichia kluyveri, and Pichia angusta), Komagataella genus (e.g. Komagataella pastoris, Komagataella pseudopastoris or Komagataella phaffii), Saccharomyces genus (e.g. Saccharomyces cerevisae, cerevisiae, Saccharomyces kluyveri, Saccharomyces uvarum), Kluyveromyces genus (e.g. Kluyveromyces lactis, Kluyveromyces marxianus), the Candida genus (e.g. Candida utilis, Candida cacaoi, Candida boidinii), the Geotrichum genus (e.g. Geotrichum fermentans), Hansenula polymorpha, Yarrowia lipolytica, or Schizosaccharomyces pombe. Preferred is the species Pichia pastoris. Examples for Pichia pastoris strains are X33, GS115, KM71, KM71H; and CBS7435.

In one embodiment, the eukaryotic cell is a fungal cell (e.g. Aspergillus (such as A. niger, A. fumigatus, A. orzyae, A. nidula), Acremonium (such as A. thermophilum), Chaetomium (such as C. thermophilum), Chrysosporium (such as C. thermophile), Cordyceps (such as C. militaris), Corynascus, Ctenomyces, Fusarium (such as F. oxysporum), Glomerella (such as G. graminicola), Hypocrea (such as H. jecorina), Magnaporthe (such as M. orzyae), Myceliophthora (such as M. thermophile), Nectria (such as N. heamatococca), Neurospora (such as N. crassa), Penicillium, Sporotrichum (such as S. thermophile), Thielavia (such as T. terrestris, T. heterothallica), Trichoderma (such as T. reesei), or Verticillium (such as V. dahlia)).

In one embodiment, the eukaryotic cell is an insect cell (e.g., Sf9, Mimic™ Sf9, Sf21, High Five™ (BT1-TN-5B1-4), or BT1-Ea88 cells), an algae cell (e.g., of the genus Amphora, Bacillariophyceae, Dunaliella, Chlorella, Chlamydomonas, Cyanophyta (cyanobacteria), Nannochloropsis, Spirulina, or Ochromonas), or a plant cell (e.g., cells from monocotyledonous plants (e.g., maize, rice, wheat, or Setaria), or from a dicotyledonous plants (e.g., cassava, potato, soybean, tomato, tobacco, alfalfa, Physcomitrella patens or Arabidopsis).

In one embodiment, the cell is a bacterial or prokaryotic cell.

In embodiments, the prokaryotic cell is a Gram-positive cells such as Bacillus, Streptomyces Streptococcus, Staphylococcus or Lactobacillus. Bacillus that can be used is, e.g. the B. subtilis, B. amyloliquefaciens, B. licheniformis, B. natto, or B. megaterium. In embodiments, the cell is B. subtilis, such as B. subtilis 3NA and B. subtilis 168. Bacillus is obtainable from, e.g., the Bacillus Genetic Stock Center, Biological Sciences 556, 484 West 12^{th} Avenue, Columbus Ohio 43210-1214.

In one embodiment, the prokaryotic cell is a Gram-negative cell, such as Salmonella spp. or Escherichia coli, such as e.g., TG1, TG2, W3110, DH1, DHB4, DH5a, HMS 174, HMS174 (DE3), NM533, C600, HB101, JM109, MC4100, XL1-Blue and Origami, as well as those derived from E. coli B-strains, such as for example BL-21 or BL21 (DE3), all of which are commercially available.

Suitable host cells are commercially available, for example, from culture collections such as the DSMZ (Deutsche Sammlung von Mikroorganismen and Zellkulturen GmbH, Braunschweig, Germany) or the American Type Culture Collection (ATCC).

In embodiments, the cultured cells are used to produce proteins e.g., antibodies, e.g., monoclonal antibodies, and/or recombinant proteins, for therapeutic use. In embodiments, the cultured cells produce peptides, amino acids, fatty acids or other useful biochemical intermediates or metabolites. For example, in embodiments, molecules having a molecular weight of about 4000 daltons to greater than about 140,000 daltons can be produced. In embodiments, these molecules can have a range of complexity and can include posttranslational modifications including glycosylation.

In embodiments, the protein is, e.g., BOTOX, Myobloc, Neurobloc, Dysport (or other serotypes of botulinum neurotoxins), alglucosidase alpha, daptomycin, YH-16, choriogonadotropin alpha, filgrastim, cetrorelix, interleukin-2, aldesleukin, teceleulin, denileukin diftitox, interferon alpha-n3 (injection), interferon alpha-nl, DL-8234, interferon, Suntory (gamma-la), interferon gamma, thymosin alpha 1, tasonermin, DigiFab, ViperaTAb, EchiTAb, CroFab, nesiritide, abatacept, alefacept, Rebif, eptoterminalfa, teriparatide (osteoporosis), calcitonin injectable (bone disease), calcitonin (nasal, osteoporosis), etanercept, hemoglobin glutamer 250 (bovine), drotrecogin alpha, collagenase, carperitide, recombinant human epidermal growth factor (topical gel, wound healing), DWP401, darbepoetin alpha, epoetin omega, epoetin beta, epoetin alpha, desirudin, lepirudin, bivalirudin, nonacog alpha, Mononine, eptacog alpha (activated), recombinant Factor VIII+VWF, Recombinate, recombinant Factor VIII, Factor VIII (recombinant), Alphnmate, octocog alpha, Factor VIII, palifermin, Indikinase, tenecteplase, alteplase, pamiteplase, reteplase, nateplase, monteplase, follitropin alpha, rFSH, hpFSH, micafungin, pegfilgrastim, lenograstim, nartograstim, sermorelin, glucagon, exenatide, pramlintide, iniglucerase, galsulfase, Leucotropin, molgramostim, triptorelin acetate, histrelin (subcutaneous implant, Hydron), deslorelin, histrelin, nafarelin, leuprolide sustained release depot (ATRIGEL), leuprolide implant (DUROS), goserelin, Eutropin, KP-102 program, somatropin, mecasermin (growth failure), enlfavirtide, Org-33408, insulin glargine, insulin glulisine, insulin (inhaled), insulin lispro, insulin deternir, insulin (buccal, RapidMist), mecasermin rinfabate, anakinra, celmoleukin, 99 mTc-apcitide injection, myelopid, Betaseron, glatiramer acetate, Gepon, sargramostim, oprelvekin, human leukocyte-derived alpha interferons, Bilive, insulin (recombinant), recombinant human insulin, insulin aspart, mecasenin, Roferon-A, interferon-alpha 2, Alfaferone, interferon alfacon-1, interferon alpha, Avonex′ recombinant human luteinizing hormone, dornase alpha, trafermin, ziconotide, taltirelin, diboterminalfa, atosiban, becaplermin, eptifibatide, Zemaira, CTC-111, Shanvac-B, HPV vaccine (quadrivalent), octreotide, lanreotide, ancestirn, agalsidase beta, agalsidase alpha, laronidase, prezatide copper acetate (topical gel), rasburicase, ranibizumab, Actimmune, PEG-Intron, Tricomin, recombinant house dust mite allergy desensitization injection, recombinant human parathyroid hormone (PTH) 1-84 (sc, osteoporosis), epoetin delta, transgenic antithrombin III, Granditropin, Vitrase, recombinant insulin, interferon-alpha (oral lozenge), GEM-21S, vapreotide, idursulfase, omnapatrilat, recombinant serum albumin, certolizumab pegol, glucarpidase, human recombinant C1 esterase inhibitor (angioedema), lanoteplase, recombinant human growth hormone, enfuvirtide (needle-free injection, Biojector 2000), VGV-1, interferon (alpha), lucinactant, aviptadil (inhaled, pulmonary disease), icatibant, ecallantide, omiganan, Aurograb, pexigananacetate, ADI-PEG-20, LDI-200, degarelix, cintredelinbesudotox, Favld, MDX-1379, ISAtx-247, liraglutide, teriparatide (osteoporosis), tifacogin, AA4500, T4N5 liposome lotion, catumaxomab, DWP413, ART-123, Chrysalin, desmoteplase, amediplase, corifollitropinalpha, TH-9507, teduglutide, Diamyd, DWP-412, growth hormone (sustained release injection), recombinant G-CSF, insulin (inhaled, AIR), insulin (inhaled, Technosphere), insulin (inhaled, AERx), RGN-303, DiaPep277, interferon beta (hepatitis C viral infection (HCV)), interferon alpha-n3 (oral), belatacept, transdermal insulin patches, AMG-531, MBP-8298, Xerecept, opebacan, AIDSVAX, GV-1001, LymphoScan, ranpirnase, Lipoxysan, lusupultide, MP52 (beta-tricalciumphosphate carrier, bone regeneration), melanoma vaccine, sipuleucel-T, CTP-37, Insegia, vitespen, human thrombin (frozen, surgical bleeding), thrombin, TransMID, alfimeprase, Puricase, terlipressin (intravenous, hepatorenal syndrome), EUR-1008M, recombinant FGF-I (injectable, vascular disease), BDM-E, rotigaptide, ETC-216, P-113, MBI-594AN, duramycin (inhaled, cystic fibrosis), SCV-07, OPI-45, Endostatin, Angiostatin, ABT-510, Bowman Birk Inhibitor Concentrate, XMP-629, 99 mTc-Hynic-Annexin V, kahalalide F, CTCE-9908, teverelix (extended release), ozarelix, rornidepsin, BAY-504798, interleukin4, PRX-321, Pepscan, iboctadekin, rhlactoferrin, TRU-015, IL-21, ATN-161, cilengitide, Albuferon, Biphasix, IRX-2, omega interferon, PCK-3145, CAP-232, pasireotide, huN901-DMI, ovarian cancer immunotherapeutic vaccine, SB-249553, Oncovax-CL, OncoVax-P, BLP-25, CerVax-16, multi-epitope peptide melanoma vaccine (MART-1, gp100, tyrosinase), nemifitide, rAAT (inhaled), rAAT (dermatological), CGRP (inhaled, asthma), pegsunercept, thymosinbeta4, plitidepsin, GTP-200, ramoplanin, GRASPA, OBI-1, AC-100, salmon calcitonin (oral, eligen), calcitonin (oral, osteoporosis), examorelin, capromorelin, Cardeva, velafermin, 131I-TM-601, KK-220, T-10, ularitide, depelestat, hematide, Chrysalin (topical), rNAPc2, recombinant Factor V111 (PEGylated liposomal), bFGF, PEGylated recombinant staphylokinase variant, V-10153, SonoLysis Prolyse, NeuroVax, CZEN-002, islet cell neogenesis therapy, rGLP-1, BIM-51077, LY-548806, exenatide (controlled release, Medisorb), AVE-0010, GA-GCB, avorelin, ACM-9604, linaclotid eacetate, CETi-1, Hemospan, VAL (injectable), fast-acting insulin (injectable, Viadel), intranasal insulin, insulin (inhaled), insulin (oral, eligen), recombinant methionyl human leptin, pitrakinra subcutancous injection, eczema), pitrakinra (inhaled dry powder, asthma), Multikine, RG-1068, MM-093, NBI-6024, AT-001, PI-0824, Org-39141, Cpn10 (autoimmune diseases/inflammation), talactoferrin (topical), rEV-131 (ophthalmic), rEV-131 (respiratory disease), oral recombinant human insulin (diabetes), RPI-78M, oprelvekin (oral), CYT-99007 CTLA4-Ig, DTY-001, valategrast, interferon alpha-n3 (topical), IRX-3, RDP-58, Tauferon, bile salt stimulated lipase, Merispase, alaline phosphatase, EP-2104R, Melanotan-II, bremelanotide, ATL-104, recombinant human microplasmin, AX-200, SEMAX, ACV-1, Xen-2174, CJC-1008, dynorphin A, SI-6603, LAB GHRH, AER-002, BGC-728, malaria vaccine (virosomes, PeviPRO), ALTU-135, parvovirus B19 vaccine, influenza vaccine (recombinant neuraminidase), malaria/HBV vaccine, anthrax vaccine, Vacc-5q, Vacc-4x, HIV vaccine (oral), HPV vaccine, Tat Toxoid, YSPSL, CHS-13340, PTH(1-34) liposomal cream (Novasome), Ostabolin-C, PTH analog (topical, psoriasis), MBRI-93.02, MTB72F vaccine (tuberculosis), MVA-Ag85A vaccine (tuberculosis), FARA04, BA-210, recombinant plague FIV vaccine, AG-702, OxSODrol, rBetV1, Der-p1/Der-p2/Der-p7 allergen-targeting vaccine (dust mite allergy), PR1 peptide antigen (leukemia), mutant ras vaccine, HPV-16 E7 lipopeptide vaccine, labyrinthin vaccine (adenocarcinoma), CML vaccine, WT1-peptide vaccine (cancer), IDD-5, CDX-110, Pentrys, Norelin, CytoFab, P-9808, VT-111, icrocaptide, telbermin (dermatological, diabetic foot ulcer), rupintrivir, reticulose, rGRF, HA, alpha-galactosidase A, ACE-011, ALTU-140, CGX-1160, angiotensin therapeutic vaccine, D-4F, ETC-642, APP-018, rhMBL, SCV-07 (oral, tuberculosis), DRF-7295, ABT-828, ErbB2-specific immunotoxin (anticancer), DT3SSIL-3, TST-10088, PRO-1762, Combotox, cholecystokinin-B/gastrin-receptor binding peptides, 111In-hEGF, AE-37, trasnizumab-DM1, Antagonist G, IL-12 (recombinant), PM-02734, IMP-321, rhIGF-BP3, BLX-883, CUV-1647 (topical), L-19 based radioimmunotherapeutics (cancer), Re-188-P-2045, AMG-386, DC/1540/KLH vaccine (cancer), VX-001, AVE-9633, AC-9301, NY-ESO-1 vaccine (peptides), NA17.A2 peptides, melanoma vaccine (pulsed antigen therapeutic), prostate cancer vaccine, CBP-501, recombinant human lactoferrin (dry eye), FX-06, AP-214, WAP-8294A (injectable), ACP-HIP, SUN-11031, peptide YY [3-36] (obesity, intranasal), FGLL, atacicept, BR3-Fc, BN-003, BA-058, human parathyroid hormone 1-34 (nasal, osteoporosis), F-18-CCR1, AT-1100 (celiac disease/diabetes), JPD-003, PTH(7-34) liposomal cream (Novasome), duramycin (ophthalmic, dry eye), CAB-2, CTCE-0214, GlycoPEGylated erythropoietin, EPO-Fc, CNTO-528, AMG-114, JR-013, Factor XIII, aminocandin, PN-951, 716155, SUN-E7001, TH-0318, BAY-73-7977, teverelix (immediate release), EP-51216, hGH (controlled release, Biosphere), OGP-I, sifuvirtide, TV4710, ALG-889, Org-41259, rhCCl0, F-991, thymopentin (pulmonary diseases), r(m)CRP, hepatoselective insulin, subalin, L19-IL-2 fusion protein, elafin, NMK-150, ALTU-139, EN-122004, rhTPO, thrombopoietin receptor agonist (thrombocytopenic disorders), AL-108, AL-208, nerve growth factor antagonists (pain), SLV-317, CGX-1007, INNO-105, oral teriparatide (eligen), GEM-OS1, AC-162352, PRX-302, LFn-p24 fusion vaccine (Therapore), EP-1043, S pneumoniae pediatric vaccine, malaria vaccine, Neisseria meningitidis Group B vaccine, neonatal group B streptococcal vaccine, anthrax vaccine, HCV vaccine (gpE1+gpE2+MF-59), otitis media therapy, HCV vaccine (core antigen+ISCOMATRIX), hPTH(1-34) (transdermal, ViaDerm), 768974, SYN-101, PGN-0052, aviscumnine, BIM-23190, tuberculosis vaccine, multi-epitope tyrosinase peptide, cancer vaccine, enkastim, APC-8024, GI-5005, ACC-001, TTS-CD3, vascular-targeted TNF (solid tumors), desmopressin (buccal controlled-release), onercept, and TP-9201.

In some embodiments, the polypeptide is adalimumab (HUMIRA), infliximab (REMICADE™), rituximab (RITUXAN™/MAB THERA™) etanercept (ENBREL™) bevacizumab (AVASTIN™), trastuzumab (HERCEPTIN™), pegrilgrastim (NEULASTA™), or any other suitable polypeptide including biosimilars and biobetters.

Other suitable polypeptides are those listed below and in Table 1 of US2016/0097074:

TABLE 3

| | Reference |
|---|---|
| Protein Product | Listed Drug |
| interferon gamma-1b | Actimmune ® |
| alteplase; tissue plasminogen activator | Activase ®/ |
| | Cathflo ® |
| Recombinant antihemophilic factor | Advate |
| human albumin | Albutein ® |
| Laronidase | Aldurazyme ® |
| Interferon alfa-N3, human leukocyte derived | Alferon N ® |
| human antihemophilic factor | Alphanate ® |
| virus-filtered human coagulation factor IX | AlphaNine ® SD |
| Alefacept; recombinant dimeric fusion protein | Amevive ® |
| LFA3-Ig | |
| Bivalirudin | Angiomax ® |
| darbepoetin alfa | Aranesp ™ |
| Bevacizumab | Avastin ™ |
| interferon beta-1a; recombinant | Avonex ® |
| coagulation factor IX | BeneFix ™ |
| Interferon beta-1b | Betaseron ® |
| Tositumomab | BEXXAR ® |
| antihemophilic factor | Bioclate ™ |
| human growth hormone | BioTropin ™ |
| botulinum toxin type A | BOTOX ® |
| Alemtuzumab | Campath ® |
| acritumomab; technetium-99 labeled | CEA-Scan ® |
| alglucerase; modified form of beta- | Ceredase ® |
| glucocerebrosidase | |
| imiglucerase; recombinant form of beta- | Cerezyme ® |
| glucocerebrosidase | |
| crotalidae polyvalent immune Fab, ovine | CroFab ™ |
| digoxin immune fab [ovine] | DigiFab ™ |
| Rasburicase | Elitek ® |
| Etanercept | ENBREL ® |
| epoietin alfa | Epogen ® |
| Cetuximab | Erbitux ™ |
| algasidase beta | Fabrazyme ® |
| Urofollitropin | Fertinex ™ |
| follitropin beta | Follistim ™ |
| Teriparatide | FORTEO ® |
| human somatropin | GenoTropin ® |
| Glucagon | GlucaGen ® |
| follitropin alfa | Gonal-F ® |
| antihemophilic factor | Helixate ® |
| Antihemophilic Factor; Factor XIII | HEMOFIL |
| adefovir dipivoxil | Hepsera ™ |
| Trastuzumab | Herceptin ® |
| Insulin | Humalog ® |
| antihemophilic factor/von Willebrand factor | Humate-P ® |
| complex-human | |
| Somatotropin | Humatrope ® |
| Adalimumab | HUMIRA ™ |
| human insulin | Humulin ® |
| recombinant human hyaluronidase | Hylenex ™ |
| interferon alfacon-1 | Infergen ® |
| eptifibatide | Integrilin ™ |
| alpha-interferon | Intron A ® |
| Palifermin | Kepivance |
| Anakinra | Kineret ™ |
| antihemophilic factor | Kogenate ® FS |
| insulin glargine | Lantus ® |
| granulocyte macrophage colony-stimulating factor | Leukine ®/ |
| | Leukine ® Liquid |
| lutropin alfa for injection | Luveris |
| OspA lipoprotein | LYMErix ™ |
| Ranibizumab | LUCENTIS ® |
| gemtuzumab ozogamicin | Mylotarg ™ |
| Galsulfase | Naglazyme ™ |
| Nesiritide | Natrecor ® |
| Pegfilgrastim | Neulasta ™ |
| Oprelvekin | Neumega ® |
| Filgrastim | Neupogen ® |
| Fanolesomab | NeutroSpec ™ |
| | (formerly |
| | LeuTech ®) |
| somatropin [rDNA] | Norditropin ®/ |
| | Norditropin |
| | Nordiflex ® |
| Mitoxantrone | Novantrone ® |
| insulin; zinc suspension; | Novolin L ® |
| insulin; isophane suspension | Novolin N ® |
| insulin, regular; | Novolin R ® |
| Insulin | Novolin ® |
| coagulation factor VIIa | NovoSeven ® |
| Somatropin | Nutropin ® |
| immunoglobulin intravenous | Octagam ® |
| PEG-L-asparaginase | Oncaspar ® |
| abatacept, fully human soluable fusion protein | Orencia ™ |
| muromomab-CD3 | Orthoclone |
| | OKT3 ® |
| high-molecular weight hyaluronan | Orthovisc ® |
| human chorionic gonadotropin | Ovidrel ® |
| live attenuated Bacillus Calmette-Guerin | Pacis ® |
| peginterferon alfa-2a | Pegasys ® |
| pegylated version of interferon alfa-2b | PEG-Intron ™ |
| Abarelix (injectable suspension); gonadotropin- | Plenaxis ™ |
| releasing hormone | |
| antagonist | |
| epoietin alfa | Procrit ® |
| Aldesleukin | Proleukin, IL-2 ® |
| Somatrem | Protropin ® |
| dornase alfa | Pulmozyme ® |
| Efalizumab; selective, reversible T-cell blocker | RAPTIVA ™ |
| combination of ribavirin and alpha interferon | Rebetron ™ |
| Interferon beta 1a | Rebi ® |
| antihemophilic factor | Recombinate ® |
| | rAHF/ |
| antihemophilic factor | ReFacto ® |
| Lepirudin | Refludan ® |
| Infliximab | REMICADE ® |
| Abciximab | ReoPro ™ |
| Reteplase | Retavase ™ |
| Rituxima | Rituxan ™ |
| interferon alfa-2^{a} | Roferon-A ® |
| Somatropin | Saizen ® |
| synthetic porcine secretin | SecreFlo ™ |
| Basiliximab | Simulect ® |
| Eculizumab | SOURIS (R) |
| Pegvisomant | SOMAVERT ® |
| Palivizumab; recombinantly produced, humanized | Synagis ™ |
| mAb | |
| thyrotropin alfa | Thyrogen ® |
| Tenecteplase | TNKase ™ |
| Natalizumab | TYSABRI ® |
| human immune globulin intravenous 5% and 10% | Venoglobulin-S ® |
| solutions | |
| interferon alfa-n1, lymphoblastoid | Wellferon ® |
| drotrecogin alfa | Xigris ™ |
| Omalizumab; recombinant DNA-derived humanized | Xolair ® |
| monoclonal | |
| antibody targeting immunoglobulin-E | |
| Daclizumab | Zenapax ® |
| ibritumomab tiuxetan | Zevalin ™ |
| Somatotropin | Zorbtive ™ |
| | (Serostim ®) |

In embodiments, the polypeptide is a hormone, blood clotting/coagulation factor, cytokine/growth factor, antibody molecule, fusion protein, protein vaccine, or peptide as shown in Table 4.

TABLE 4
Exemplary Products

| Therapeutic | | |
|---|---|---|
| Product type | Product | Trade Name |
| Hormone | Erythropoietin, Epoein-a | Epogen, Procrit |
| | Darbepoetin-a | Aranesp |
| | Growth hormone (GH), | Genotropin, Humatrope, Norditropin, |
| | somatotropin | NovIVitropin, Nutropin, Omnitrope, |
| | | Protropin, Siazen, Serostim, Valtropin |
| | Human follicle-stimulating | Gonal-F, Follistim |
| | hormone (FSH) | |
| | Human chorionic | Ovidrel |
| | gonadotropin | Luveris |
| | Lutropin-a | GlcaGen |
| | Glucagon | Geref |
| | Growth hormone releasing | ChiRhoStim (human peptide), SecreFlo |
| | hormone (GHRH) | (porcine peptide) |
| | Secretin | Thyrogen |
| | Thyroid stimulating | |
| | hormone (TSH), thyrotropin | |
| Blood | Factor VIIa | NovoSeven |
| Clotting/Coagulation | Factor VIII | Bioclate, Helixate, Kogenate, |
| Factors | | Recombinate, ReFacto |
| | Factor IX | |
| | Antithrombin III (AT-III) | Benefix |
| | Protein C concentrate | Thrombate III |
| | | Ceprotin |
| Cytokine/Growth | Type I alpha-interferon | Infergen |
| factor | Interferon-an3 (IFNan3) | Alferon N |
| | Interferon-b1a (rIFN-b) | Avonex, Rebif |
| | Interferon-b1b (rIFN-b) | Betaseron |
| | Interferon-g1b (IFN g) | Actimmune |
| | Aldesleukin (interleukin | Proleukin |
| | 2(IL2), epidermal | |
| | theymocyte activating | |
| | factor; ETAF | Kepivance |
| | Palifermin (keratinocyte | Regranex |
| | growth factor; KGF) | |
| | Becaplemin (platelet- | Anril, Kineret |
| | derived growth factor; | |
| | PDGF) | |
| | Anakinra (recombinant IL1 | |
| | antagonist) | |
| Antibody molecules | Bevacizumab (VEGFA | Avastin |
| | mAb) | Erbitux |
| | Cetuximab (EGFR mAb) | Vectibix |
| | Panitumumab (EGFR mAb) | Campath |
| | Alemtuzumab (CD52 mAb) | Rituxan |
| | Rituximab (CD20 chimeric | Herceptin |
| | Ab) | Orencia |
| | Trastuzumab (HER2/Neu | Humira |
| | mAb) | Enbrel |
| | Abatacept (CTLA Ab/Fc | |
| | fusion) | Remicade |
| | Adalimumab (TNFa mAb) | Amevive |
| | Etanercept (TNF | Raptiva |
| | receptor/Fc fusion) | Tysabri |
| | Infliximab (TNFa chimeric | Soliris |
| | mAb) | Orthoclone, OKT3 |
| | Alefacept (CD2 fusion | |
| | protein) | |
| | Efalizumab (CD11a mAb) | |
| | Natalizumab (integrin a4 | |
| | subunit mAb) | |
| | Eculizumab (C5mAb) | |
| | Muromonab-CD3 | |
| Other: | Insulin | Humulin, Novolin |
| Fusion | Hepatitis B surface antigen | Engerix, Recombivax HB |
| proteins/Protein | (HBsAg) | |
| vaccines/Peptides | HPV vaccine | Gardasil |
| | OspA | LYMErix |
| | Anti-Rhesus(Rh) | Rhophylac |
| | immunoglobulin G | Fuzeon |
| | Enfuvirtide | |
| | Spider silk, e.g., fibrion | QMONOS |

In embodiments, the protein is multispecific protein, e.g., a bispecific antibody as shown in Table 5.

TABLE 5
Bispecific Formats

| Name (other | | | | | |
|---|---|---|---|---|---|
| names, | | | Proposed | | Diseases (or |
| sponsoring | BsAb | | mechanisms of | Development | healthy |
| organizations) | format | Targets | action | stages | volunteers) |
| Catumaxomab | BsIgG; | CD3, | Retargeting of T | Approved in | Malignant ascites |
| (Removab ®, | Triomab | EpCAM | cells to tumor, Fc | EU | in EpCAM |
| Fresenius Biotech | | | mediated effector | | positive tumors |
| Trion Pharma, | | | functions | | |
| Neopharm) | | | | | |
| Ertumaxomab | BsIgG; | CD3, HER2 | Retargeting of T | Phase I/II | Advanced solid |
| (Neovii Biotech, | Triomab | | cells to tumor | | tumors |
| Fresenius Biotech) | | | | | |
| Blinatumomab | BiTE | CD3, CD19 | Retargeting of T | Approved in | Precursor B-cell |
| (Blincyto ®, AMG | | | cells to tumor | USA | ALL |
| 103, MT 103, | | | | Phase II and | ALL |
| MEDI 538, | | | | III | DLBCL |
| Amgen) | | | | Phase II | NHL |
| | | | | Phase I | |
| REGN1979 | BsAb | CD3, CD20 | | | |
| (Regeneron) | | | | | |
| Solitomab (AMG | BiTE | CD3, | Retargeting of T | Phase I | Solid tumors |
| 110, MT110, | | EpCAM | cells to tumor | | |
| Amgen) | | | | | |
| MEDI 565 (AMG | BiTE | CD3, CEA | Retargeting of T | Phase I | Gastrointestinal |
| 211, MedImmune, | | | cells to tumor | | adenocancinoma |
| Amgen) | | | | | |
| RO6958688 | BsAb | CD3, CEA | | | |
| (Roche) | | | | | |
| BAY2010112 | BiTE | CD3, PSMA | Retargeting of T | Phase I | Prostate cancer |
| (AMG 212, Bayer; | | | cells to tumor | | |
| Amgen) | | | | | |
| MGD006 | DART | CD3, CD 123 | Retargeting of T | Phase I | AML |
| (Macrogenics) | | | cells to tumor | | |
| MGD007 | DART | CD3, gpA33 | Retargeting of T | Phase I | Colorectal cancer |
| (Macrogenics) | | | cells to tumor | | |
| MGD011 | DART | CD19, CD3 | | | |
| (Macrogenics) | | | | | |
| SCORPION | BsAb | CD3, CD19 | Retargeting of T | | |
| (Emergent | | | cells to tumor | | |
| Biosolutions, | | | | | |
| Trubion) | | | | | |
| AFM11 (Affimed | TandAb | CD3, CD19 | Retargeting of T | Phase I | NHL and ALL |
| Therapeutics) | | | cells to tumor | | |
| AFM12 (Affimed | TandAb | CD19, CD16 | Retargeting of NK | | |
| Therapeutics) | | | cells to tumor | | |
| | | | cells | | |
| AFM13 (Affimed | TandAb | CD30, | Retargeting of NK | Phase II | Hodgkin's |
| Therapeutics) | | CD16A | cells to tumor | | Lymphoma |
| | | | cells | | |
| GD2 (Barbara Ann | T cells | CD3, GD2 | Retargeting of T | Phase I/II | Neuroblastoma |
| Karmanos Cancer | preloaded | | cells to tumor | | and |
| Institute) | with BsAb | | | | osteosarcoma |
| pGD2 (Barbara | T cells | CD3, Her2 | Retargeting of T | Phase II | Metastatic breast |
| Ann Karmanos | preloaded | | cells to tumor | | cancer |
| Cancer Institute) | with BsAb | | | | |
| EGFRBi-armed | T cells | CD3, EGFR | Autologous | Phase I | Lung and other |
| autologous | preloaded | | activated T cells | | solid tumors |
| activated T cells | with BsAb | | to EGFR-positive | | |
| (Roger Williams | | | tumor | | |
| Medical Center) | | | | | |
| Anti-EGFR-armed | T cells | CD3, EGFR | Autologous | Phase I | Colon and |
| activated T-cells | preloaded | | activated T cells | | pancreatic |
| (Barbara Ann | with BsAb | | to EGFR-positive | | cancers |
| Karmanos Cancer | | | tumor | | |
| Institute) | | | | | |
| rM28 (University | Tandem | CD28, | Retargeting of T | Phase II | Metastatic |
| Hospital Tubingen) | scFv | MAPG | cells to tumor | | melanoma |
| IMCgp100 | ImmTAC | CD3, peptide | Retargeting of T | Phase I/II | Metastatic |
| (Immunocore) | | MHC | cells to tumor | | melanoma |
| DT2219ARL | 2 scFv | CD19, CD22 | Targeting of | Phase I | B cell leukemia |
| (NCI, University of | linked to | | protein toxin to | | or lymphoma |
| Minnesota) | diphtheria | | tumor | | |
| | toxin | | | | |
| XmAb5871 | BsAb | CD19, | | | |
| (Xencor) | | CD32b | | | |
| NI-1701 | BsAb | CD47, CD19 | | | |
| (Novlmmune) | | | | | |
| MM-111 | BsAb | ErbB2, | | | |
| (Merrimack) | | ErbB3 | | | |
| MM-141 | BsAb | IGF-1R, | | | |
| (Merrimack) | | ErbB3 | | | |
| NA (Merus) | BsAb | HER2, | | | |
| | | HER3 | | | |
| NA (Merus) | BsAb | CD3, | | | |
| | | CLEC12A | | | |
| NA (Merus) | BsAb | EGFR, | | | |
| | | HER3 | | | |
| NA (Merus) | BsAb | PD1, | | | |
| | | undisclosed | | | |
| NA (Merus) | BsAb | CD3, | | | |
| | | undisclosed | | | |
| Duligotuzumab | DAF | EGFR, | Blockade of 2 | Phase I and II | Head and neck |
| (MEHD7945A, | | HER3 | receptors, ADCC | Phase II | cancer |
| Genentech, Roche) | | | | | Colorectal cancer |
| LY3164530 (Eli | Not | EGFR, MET | Blockade of 2 | Phase I | Advanced or |
| Lily) | disclosed | | receptors | | metastatic cancer |
| MM-111 | HSA body | HER2, | Blockade of 2 | Phase II | Gastric and |
| (Merrimack | | HER3 | receptors | Phase I | esophageal |
| Pharmaceuticals) | | | | | cancers |
| | | | | | Breast cancer |
| MM-141, | IgG-scFv | IGF-1R, | Blockade of 2 | Phase I | Advanced solid |
| (Merrimack | | HER3 | receptors | | tumors |
| Pharmaceuticals) | | | | | |
| RG7221 | CrossMab | Ang2, VEGF A | Blockade of 2 | Phase I | Solid tumors |
| (RO5520985, | | | proangiogenics | | |
| Roche) | | | | | |
| RG7716 (Roche) | CrossMab | Ang2, VEGF A | Blockade of 2 | Phase I | Wet AMD |
| | | | proangiogenics | | |
| OMP-305B83 | BsAb | DLL4/VEGF | | | |
| (OncoMed) | | | | | |
| TF2 | Dock and | CEA, HSG | Pretargeting | Phase II | Colorectal, |
| (Immunomedics) | lock | | tumor for PET or | | breast and lung |
| | | | radioimaging | | cancers |
| ABT-981 | DVD-Ig | IL-1α, IL-1β | Blockade of 2 | Phase II | Osteoarthritis |
| (AbbVie) | | | proinflammatory | | |
| | | | cytokines | | |
| ABT-122 | DVD-Ig | TNF, IL-17A | Blockade of 2 | Phase II | Rheumatoid |
| (AbbVie) | | | proinflammatory | | arthritis |
| | | | cytokines | | |
| COVA322 | IgG- | TNF, IL17A | Blockade of 2 | Phase I/II | Plaque psoriasis |
| | fynomer | | proinflammatory | | |
| | | | cytokines | | |
| SAR156597 | Tetravalent | IL-13, IL-4 | Blockade of 2 | Phase I | Idiopathic |
| (Sanofi) | bispecific | | proinflammatory | | pulmonary |
| | tandem IgG | | cytokines | | fibrosis |
| GSK2434735 | Dual- | IL-13, IL-4 | Blockade of 2 | Phase I | (Healthy |
| (GSK) | targeting | | proinflammatory | | volunteers) |
| | domain | | cytokines | | |
| Ozoralizumab | Nanobody | TNF, HSA | Blockade of | Phase II | Rheumatoid |
| (ATN103, Ablynx) | | | proinflammatory | | arthritis |
| | | | cytokine, binds to | | |
| | | | HSA to increase | | |
| | | | half-life | | |
| ALX-0761 (Merck | Nanobody | IL-17A/F, | Blockade of 2 | Phase I | (Healthy |
| Serono, Ablynx) | | HSA | proinflammatory | | volunteers) |
| | | | cytokines, binds | | |
| | | | to HSA to | | |
| | | | increase half-life | | |
| ALX-0061 | Nanobody | IL-6R, HSA | Blockade of | Phase I/II | Rheumatoid |
| (AbbVie, Ablynx; | | | proinflammatory | | arthritis |
| | | | cytokine, binds to | | |
| | | | HSA to increase | | |
| | | | half-life | | |
| ALX-0141 | Nanobody | RANKL, | Blockade of bone | Phase I | Postmenopausal |
| (Ablynx, | | HSA | resorption, binds | | bone loss |
| Eddingpharm) | | | to HSA to | | |
| | | | increase half-life | | |
| RG6013/ACE910 | ART-Ig | Factor IXa, | Plasma | Phase II | Hemophilia |
| (Chugai, Roche) | | factor X | coagulation | | |

What is claimed is:

1. A method of providing a virtual reality or augmented reality display, comprising acts of:
generating, with a camera of a device, first video content comprising a depiction of a component of a facility for the processing of a pharmaceutical product;
detecting or selecting the component; and
generating second video content comprising a first indicator associated with the component, the first video content and the second video content providing a virtual reality or augmented reality display.

2. The method of claim 1, wherein the indicator is associated with one or more of: (i) an identity or type of the component, (ii) information related to maintenance or replacement of the component, (iii) information related to a second component that is functionally linked to the component, (iv) information or a value related to a function, a condition or a status of the component, (v) information related to a service life of the component, (vi) information related to an age of the component, (vii) information related to a date the component was installed, (viii) information related to a manufacturer of the component, (ix) information related to an availability of a replacement for the component, (x) information associated with a location of the replacement for the component, (xi) information related to an expected life cycle of the component, (xii) information related to a temperature of the component; (xiii) information related to a temperature of a material in the component; (xiv) information related to a flow rate through the component, (xv) information related to a pressure in the component, and (xvi) information related to an event or an inspect of the component.

3. The method of claim 1, further comprising generating third video content comprising a second indicator.

4. The method of claim 2, wherein the value related to the function, the condition, or the status of the component comprises a current or real time value, a historical or past value, or a preselected value.

5. The method of claim 1, wherein the component is (i) a tank, (ii) an evaporator, (iii) a pipe, (iv) a centrifuge, (v) a filter, (vi) a press, (vii) a mixer, (viii) a conveyor, (ix) a reactor, (x) a boiler, (xi) a fermentor, (xii) a pump, (xiii) a condenser, (xiv) a scrubber, (xv) a valve, (xvi) a separator, (xvii) a gauge, (xviii) a dryer, (xix) a heat exchanger, (xx) a cooker, (xxi) a regulator, (xxii) a decanter, (xxiii) a column, (xxiv) a freezer, (xxv) a chromatography skid, (xxvi) an incubator, or (xxvii) a flow plate.

6. The method of claim 1, further comprising displaying, on a display device, a depiction of all or part of one or more of: (i) the component and (ii) the indicator.

7. The method of claim 1, further comprising composing a display comprising all or part of the first video content and all or part of the second video content.

8. The method of claim 1, wherein all or part of the first video content is overlaid with all or part of the second video content, the first and second video content being live or recorded.

9. The method of claim 1, wherein the first video content comprises a depiction of a plurality of components, and further comprising receiving, at a display device, a selection of one of the plurality of components.

10. The method of claim 1, further comprising determining at least one action item to be performed related to the component.

11. A display device comprising:
a camera configured to receive and capture images associated with a first video content comprising a depiction of a component of an industrial facility for the processing of a drug or a biological product;
a display screen configured to be positioned to be visible to a user of the display device; and
at least one processor configured to:
generate the first video content comprising a depiction of a component of an industrial facility for the processing of a drug or a biological product;
generate second video content comprising an indicator associated with the component; and
display the first video content and the second video content as an augmented reality or virtual reality display.

12. The device of claim 11, wherein the display device is a wearable device configured to be positioned in a field of vision of a wearer or a user.

13. The device of claim 11, further comprising a user interface configured to receive a user input, wherein the user input is a gesture detectable in the first video content.

14. The device of claim 11, further comprising a location receiver configured to obtain location information, wherein the at least one processor is further configured to identify the component based at least in part on the location information.

15. The device of claim 11, further comprising a radio receiver configured to receive a proximity signal from a signaling device on or near the component, wherein the at least one processor is further configured to identify the component based at least in part on the proximity signal.

16. The device of claim 11, further comprising a network interface configured to communicate with at least one computing device via a network.

17. The device of claim 11, further comprising one or more of: (i) a gyroscope, (ii) an accelerometer, and (iii) a compass.

18. A method of displaying visual content, the method comprising:
displaying, to a user of a display device, a display composed of: (i) first video content comprising a depiction of a component of an industrial facility for the processing of a drug or a biological product and (ii) second video content comprising an indicator associated with the component, wherein the first video content and the second video content provides an augmented reality display and/or a virtual reality display; and
receiving user input via a user interface of the display device.

19. The method of claim 18, wherein the user input includes associating a further indicator with a different user.

20. The method of claim 18, further comprising sending a signal to an entity based on the indicator or based on a value associated with the indicator.

21. The method of claim 18, further comprising:
detecting, in the first video content, an event associated with the component; and
creating a further indicator relating to the event.

22. The method of claim 18, wherein the indicator comprises information related to an action item to be performed associated with the component.

23. The method of claim 22, wherein the action item is presented in a task list in the second video content.

24. The method of claim 22, wherein the action item relates to one or more of: (i) a maintenance task and (ii) an industrial process involving the component.

25. The method of claim 18, wherein the second video content includes a further indicator providing a direction to a location of the component.

26. The method of claim 18, wherein some or all of the second video content is displayed in a color corresponding to a characteristic of the component, the indicator, or a value of the indicator.

27. The method of claim 26, wherein the characteristic is a type of the component, an identifier of the component, an identifier of a material stored or transmitted by the component, or a temperature of the material stored or transmitted by the component.
